(19) United States
(12) Patent Application Publication
(10) Pub. No.: US 2018/0081118 A1
(43) Pub. Date: Mar. 22, 2018

(54) PHOTONIC INTEGRATION BY FLIP-CHIP BONDING AND SPOT-SIZE CONVERSION

(71) Applicant: Biond Photonics Inc., Oceanside, NY (US)

(72) Inventors: Jonathan Klamkin, Brookline, MA (US); Sasa Ristic, Montreal (CA)

(73) Assignee: Biond Photonics Inc., Oceanside, NY (US)

(21) Appl. No.: 15/583,716

(22) Filed: May 1, 2017

Related U.S. Application Data
(63) Continuation of application No. PCT/US2015/058643, filed on Nov. 2, 2015.
Application No. PCT/US2015/058643 is a continuation-in-part of application No. PCT/US2015/040344, filed on Jul. 14, 2015.
(60) Provisional application No. 62/073,837, filed on Oct. 31, 2014.
(60) Provisional application No. 62/024,379, filed on Jul. 14, 2014.

(51) Int. Cl. G02B 6/122; G02B 6/42

(52) U.S. Cl. CPC G02B 6/1228; G02B 6/34; G02B 6/4208

(57) ABSTRACT

Two or more monolithic or heterogeneously integrated substrates are attached to each other and optically edge-coupled using spot-size converters. Spot-size converters are placed between planar optical waveguides and cleaved or etched facets in each substrate. The facets are provide optical edge coupling and the spot-size converters are used to adjust at least the size, shape, and divergence of the optical beams entering or exiting the optical waveguides as to improve the optical coupling between the substrates. In addition to spot-size converters, filtering and other light adjusting elements may be placed between the substrates. Integrated lasers, semiconductor optical amplifiers, and photonic integrated circuits can be provided with complementary metal-oxide semiconductor (CMOS)-compatible silicon (Si) photonic substrates, which can also contain integrated electronics.

### CROSS REFERENCE TO RELATED APPLICATIONS

This application is a continuation of International Application No. PCT/US2015/058643, filed Nov. 2, 2015, which claims the benefit of U.S. Provisional Application No. 62/073,837, filed Oct. 31, 2014, which is incorporated by reference herein. International Application No. PCT/US2015/058643 is a continuation-in-part of International Application No. PCT/US2015/040344, filed Jul. 14, 2015, which claims the benefit of U.S. Provisional Application No. 62/024,379, filed Jul. 14, 2014, both of which are incorporated by reference herein.

### FIELD OF THE DISCLOSURE

The disclosure pertains to semiconductor optoelectronic devices, and, more specifically, to the integration of different optoelectronic devices through light coupling elements such as spot-size converters, facets, surface gratings, and lenses.

### BACKGROUND

Silicon (Si) photonics has emerged as an effective photonic integration platform for realizing high-functionality photonic integrated circuits (PICs) that comprise more than one photonic function on a chip. This technology platform can realize compact transmitters and receivers for optical communication, sensing, and other applications. Passive components such as, but not limited to, optical splitters, combiners, arrayed waveguide gratings (AWGs), and echelle gratings, can be fabricated in Si with excellent performance and small size. Some active components have also been demonstrated in Si including optical modulators based on P-N junctions and photodiodes (PDs) based on germanium (Ge) on Si (Ge/Si) or ion implantation. Although the performance of these components is reasonable, for some applications it would be beneficial to have higher performance afforded by other material systems such as, but not limited to, lithium niobate (LiNbO₃), indium phosphide (InP), or gallium arsenide (GaAs).

Realizing laser sources on Si is extremely challenging because Si has an indirect bandgap and therefore it is not efficient for light emission. Direct bandgap group III-V semiconductors such as InP or GaAs, on the other hand, make for efficient light emitters. One solution is to simply co-package a laser fabricated from a III-V material, such as InP, that emits light at typical optical communication wavelengths, and couple the light from the laser chip to the Si using microoptics. This is a fairly cumbersome approach that requires several microoptics components including a lens and an optical isolator. This approach also does not scale well for applications that require more than one laser source.

On-chip integration approaches have been proposed such as integration of an InP laser chip directly on the Si chip. In this case the laser chip can be attached to the Si chip by flip-chip bonding and the light is butt-coupled, i.e., edge-coupled, from the InP planar waveguide to the Si planar waveguide. This approach does not use spot size convertors and requires precise horizontal and vertical alignment.

Another approach relies on wafer bonding of InP to Si and then the subsequent removal of the InP substrate and post-bonding fabrication of the InP chip. The light generated in the InP gain medium, which is positioned directly above a Si waveguide, evanescently couples to the Si waveguide. This approach relies on an extremely sensitive wafer-bonding step, which poses yield issues. It also requires processing incompatible materials and exhibits inherent reliability issues because the two materials have significantly different coefficients of thermal expansion, and these materials are brought into intimate contact through wafer bonding. Although the wafer bonding approach allows for scalability (i.e. increasing number of lasers on a Si chip), to be executed effectively, it requires fabrication of both the InP and Si materials in the same facility. These are incompatible materials and therefore significant investments are required for this approach to be practical. Also, an active InP material is wafer bonded to a Si waveguide that is placed on top of a buried oxide layer (BOX), which has large thermal impedance and obstructs the heat extraction that is offered by the Si substrate. Consequently, the wafer bonded laser, semiconductor optical amplifiers, and other active devices, suffer from impaired performance in uncooled, high-power, nonlinear, microwave, and other photonic applications.

### SUMMARY

Photonic integration by optical edge coupling, often referred to as butt coupling, of two or more substrates or devices allows for improved functionality and performance of the resulting photonic circuits. According to one embodiment, addition of spot-size converters to both of any-two optically edge-coupled substrates generally improves coupling by, for example, reducing optical losses, improving alignment tolerances, and reducing optical reflections at coupling interfaces. In each of the two optically coupled substrates that are directly or indirectly attached to each other, a spot-size converter can be positioned in the following manner. At one end, the spot-size converter is optically coupled to a planar optical waveguide positioned in the horizontal plane of the substrate. At another end, the spot-size converter is optically coupled to a cleaved or etched facet, a facet that may be coated, a facet that may not necessarily be vertical (i.e., it may be defined at some other angle than a 90-degree angle relative to a major (horizontal) plane of the substrate, a facet that may be angled in the horizontal plane, relative to optical beam entering or exiting the substrate, a facet the may not be perfectly flat (i.e., it may be curved), or a facet that is optically aligned to a corresponding facet on the other optically coupled substrate. In some other examples, BOX layers can be removed in bonding areas between InP and Si, improving thermal performance of the resulting circuits and devices.

These and other features of the disclosed technology are described below with reference to the accompanying drawings.

### BRIEF DESCRIPTION OF THE DRAWINGS

FIG. 1 is an isometric-view schematic of a device (top PIC), showing its front, spot-size converted side, where the device is used in a photonic integration scheme in accordance with an embodiment of the invention;

FIG. 2 is an isometric-view schematic of a device (top PIC), showing its backside, where the device is used in a photonic integration scheme in accordance with an embodiment of the invention;

FIG. 3 is an isometric-view schematic of a spot-size converted device (bottom PIC), where the device is used in a photonic integration scheme in accordance with an embodiment of the invention;

FIG. 4 is an isometric-view schematic of a device (bottom PIC), showing its spot-size converter, where the device is used in a photonic integration scheme in accordance with an embodiment of the invention;

FIG. 5 is an isometric-view schematic of two spot-size converted devices (top PIC and bottom PIC), in a position preceding their attachment to each other in a photonic integration scheme in accordance with an embodiment of the invention;

FIG. 6 is an isometric-view schematic of top PIC device, showing its front side, and bottom PIC device, following their attachment to each other in a photonic integration scheme in accordance with an embodiment of the invention;

FIG. 7 is an isometric-view schematic of top PIC device, showing its backside, and bottom PIC device, following their attachment to each other in a photonic integration scheme in accordance with an embodiment of the invention;

FIG. 8 is an isometric close-up view schematic of top PIC device, showing its backside, and bottom PIC device, following their attachment to each other in a photonic integration scheme in accordance with an embodiment of the invention;

FIG. 9 is an isometric-view schematic of top PIC device bonded to bottom PIC device, showing the metal pad on bottom PIC device (200), metal pad on top PIC device (201), and the corresponding wirebond (202) backside in accordance with an embodiment of the invention;

FIG. 10 is a sideview schematic of a spot-size converted DFB laser based on a vertically coupled spot-size converter in accordance with an embodiment of the invention;

FIG. 11 is a sideview schematic of a spot-size converted DFB laser based on an evanescently coupled spot-size converter in accordance with an embodiment of the invention;

FIG. 12 is a topview schematic of a buried type of SSC, also showing simulated mode profiles on either side of the SSC as well as the horizontal and vertical alignment tolerances, in accordance with an embodiment of the invention;

FIG. 13 is a topview and a sideview schematic of a spot-size converted DFB laser based on a buried spot-size converter in accordance with an embodiment of the invention;

FIG. 14 is a sideview schematic of a spot-size converted DFB laser based on a grating-assisted spot-size converter in accordance with an embodiment of the invention;

FIG. 15 is a sideview schematic illustrating angled-wall pit features that aid in self-aligning of the chips being bonded in accordance with an embodiment of the invention;

FIG. 16 is a sideview schematic of two monolithic substrates being optically coupled and bonded to each other, where the coupling facets are not placed at the outer edges of the respective substrates in accordance with an embodiment of the invention;

FIG. 17 is a sideview schematic of two substrates being optically coupled and bonded to each other, and where at least one of the substrates is heterogeneously integrated in accordance with an embodiment of the invention;

FIG. 18 is a sideview schematic of two substrates being optically coupled and bonded to each other, and where at least one of the substrates is heterogeneously integrated and uses recessed surfaces or pedestals in one of its constitutive parts in order to facilitate the optical alignment between the two substrates in accordance with an embodiment of the invention;

FIG. 19 is a sideview schematic of two substrates being optically coupled and bonded to each other, and where at least one of the substrates is heterogeneously integrated and uses an heterogeneously integrated SSC in accordance with an embodiment of the invention;

FIG. 20 is a sideview schematic of two substrates being optically coupled and bonded to each other, and where at least one of the substrates is heterogeneously integrated and bonded as top substrate in accordance with an embodiment of the invention;

FIG. 21 is a flow diagram illustrating the process for integrating photonic devices to form a photonic integrated circuit in accordance with an embodiment of the invention.

FIG. 22 is a block diagram schematic of a spot-size converted device comprising at least a horizontal (with respect to the plane of the substrate) waveguide, and an edge-emitting spot-size converter in accordance with an embodiment of the invention;

FIG. 23 is a sideview schematic of a grating-based SSC where the grating radiation is in the SSC superstrate;

FIG. 24 is a sideview schematic of a grating-based SSC where the grating radiation is in the SSC substrate.

FIG. 25 is a sideview schematic of a grating-based SSC where the grating directs radiation into the SSC substrate.

FIG. 26 is a sideview schematic of a grating-based SSC where the grating directs radiation to a reflector such as a reflective facet that is angled so as that radiation exits the SSC substrate at a bottom major surface, and not an edge.

FIG. 27 is a sideview schematic of a grating-based SSC where the grating directs radiation to a reflector such as a reflective facet that is angled so as that radiation exits the SSC substrate at a top major surface, and not an edge.

FIG. 28 is a sideview schematic of a grating-based SSC where the grating directs radiation so as to exit the SSC substrate at a top major surface, and not an edge.

FIG. 29 is a sideview schematic of a grating-based SSC where the grating directs radiation to a reflector such as a reflective facet that is angled so as that radiation exits the SSC substrate at a bottom major surface, and not an edge.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items, and the term “directly coupled” is used to refer to coupling absent intermediate elements.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

As used herein, optical waveguides have axes along which optical modes propagate. Such axes are typically linear, but can be curved, or be formed of combinations of linear and curved sections. In some cases, optical waveguide axes can be bent, folded, or curved with optical elements or by establishing refractive index differences that define a waveguide along one or more linear or curved axes or combinations thereof. As used herein, an axis or a beam axis refers to an optical axis associated with waveguide propagation, or with beam propagation along one or more other directions, within or without a waveguide. In some cases, an axis will be understood to include one or more segments, and an optical axis can be bent, folded, curved or otherwise shaped using one or more prisms, mirrors, diffraction gratings, or other optics which may or may not be integrated into a substrate. For convenience, propagating optical radiation can be referred to as a beam or an optical beam.

In the examples disclosed herein, optical devices such as waveguides, emitters, detectors, and other optical elements are defined in planar substrates (in some cases, referred to as wafers) that include generally planar major surfaces that are separated by distances on the order of 1 μm to 1 mm. Planar waveguides are defined in planes parallel to the major surfaces, and are referred to in some cases as horizontal waveguides for convenient description. Beam propagation can be referred to as horizontal or vertical, or in-plane and out-of-plane as may be convenient.

Typically, beams propagating in a plane of a substrate in, for example, a planar waveguide, are coupled out of the substrate at a substrate facet that is situated along a beam propagation axis. A facet is typically a planar or curved optical surface defined in a substrate edge between the major surfaces. A facet can also be a planar or curved optical surface defined anywhere in the substrate situated along a beam propagating axis as to at least partly redirect or reflect the beam. The facet can be planar or curved, and can be perpendicular to the major surfaces, or angled with respect to the major surfaces. The facet can be oriented so that a vector normal to the facet surface (at any location on the facet surface) can have non-zero components along any or all of three spatial directions of a Cartesian (x, y, z) coordinate system. In some cases, such a normal vector is parallel to a waveguide axis or other optical axis defined in a substrate, but such a normal vector can be at an arbitrary angle. Facets having surface normals that are not parallel to a major surface of the substrate in which the facet is defined and that are also not parallel to a beam propagation axis that optically couples the facet to one or more optical waveguides defined in the substrate are referred to as compound angles. A facet may extend from a first major surface of a wafer or other substrate to a second major surface, or may occupy only a portion of a surface that extends between the major surfaces. As noted above, facets need not be located at substrate edges. A facet may also be a surface locally defined anywhere in the substrate at a position at which an optical beam enters or leaves a substrate by being at least partly transmitted through the facet or at the position at which a beam is at least partially reflected by the facet. In some examples, a beam propagation axis after transmission by a facet is changed due to refractive index differences. Typically, a facet extends from a first major surface of a wafer or other substrate to a second major surface. For convenience, some facets are referred to as edge facets. Facets can be formed at substrate edges by etching, cleaving, or other mechanical or chemical processes. Typical facet angles (angle between a normal to a facet and a projection of the normal onto a plane that is parallel to a substrate major axis) are at least 0.1, 0.2, 0.5, 0.7, 1.0, 1.5, 2.0, 7.0, and 10.0 degrees.

Facets need not be physically close to the position where the beam is coupled into or out of the substrate. In some disclosed examples, a facet is situated to reflect light to and/or from another substrate surface such as a major surface or a surface etched or otherwise formed in the major surface, but not at a substrate edge. In this way, an optical beam can be directed into or out of a substrate at an arbitrary substrate location. The substrate surface separation (in some cases, the substrate thickness), can be greater than 0.5 mm, 1.0 mm, 2.0 mm, or more. In this way, beams propagating in a plane of a substrate in, for example, a planar waveguide, can be coupled into or out of the substrate at a substrate facet that is at least partially reflective and that is situated along a beam propagation axis anywhere on the substrate.

As noted above, axes are sometimes referred to as horizontal and vertical but such designation does not imply any further spatial orientation. In addition, one or more prisms, mirrors, lenses, diffraction gratings, or other optics (referred to herein as beam direction transitions) can be situated so as to couple optical beams into and out of the horizontal waveguide along an axis that is not parallel or co-planar with an axis of a planar waveguide. In some examples, the beam direction transition is situated to direct a beam propagating in or to the planar waveguide along an axis that is out of plane to a substrate major surface so as to couple beams into and out of an optical substrate.

The term “substrate” is used to refer to wafers, disks, or other shapes that are processed so as to define components of one or more photonic circuits as well as portions of such substrates in which such components are fabricated, such as obtained after cleaving, dicing, or other operation used to separate a such components and photonic circuits from a larger substrate.

Optical radiation is referred to as propagating in one or more optical beams. For convenience, beam cross-sectional area is referred to as beam spot size, beam diameter, mode field size, or mode field diameter. While optical beams may in some cases have circular beam cross-sections, optical beams more generally have spot sizes or beam cross-sections that are elliptical or that can be characterized as having different dimensions along different cross-sectional axes. For example, diverging beams produced by laser diodes can be referred to a having slow and fast axes that are associated with differing beam divergences. Accordingly, as described herein, a spot size convertor can alter a beam size along a single axis, and need not alter beam size along two dimensions.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Disclosed herein are methods and systems of photonic integration of two or more photonic integrated circuits (PICs), which are also often referred to as optoelectronic integrated circuits (OEICs). This photonic integration is generally a combination of one or more of the following three elements: (1) Bonding of one PIC onto another PIC; (2) Use of spot-size converters (SSCs) as input/output optical ports of the PICs; and (3) Insertion of a part of the flip-chip bonded PIC into a recessed area of another PIC to enable horizontal coupling between their input/output spot-size converted optical ports.

A number of bonding techniques can be utilized, including, but not limited to, flip-chip bonding, metal-to-metal thermocompression bonding, ultrasonic bonding, solder bonding, direct bonding (with or without an interfacial layer), or adhesive bonding. Typically one chip is referred to as a flip chip, and flip-chip bonding as an attachment technique, but the disclosure applies to other techniques for attaching one chip to another, or multiple chips to another. The examples below show primarily one PIC attached to another PIC. This technique can be applied, however, to the attachment of several PICs to one larger PIC, and can be carried out at the wafer level meaning PICs can be attached to the dies of a full wafer.

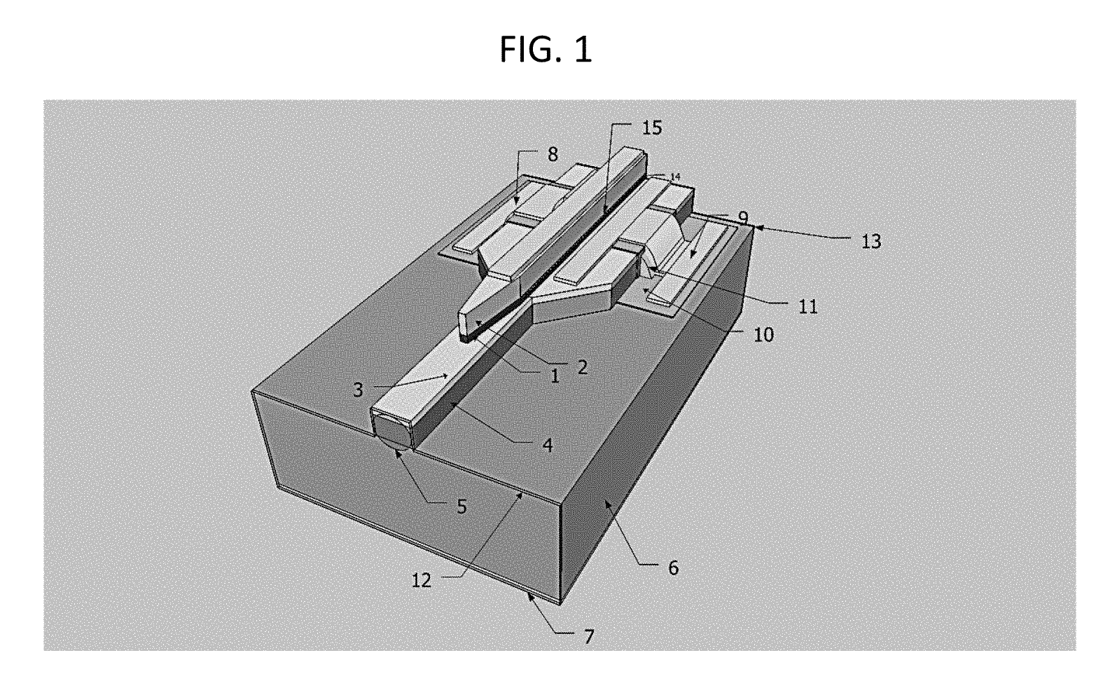

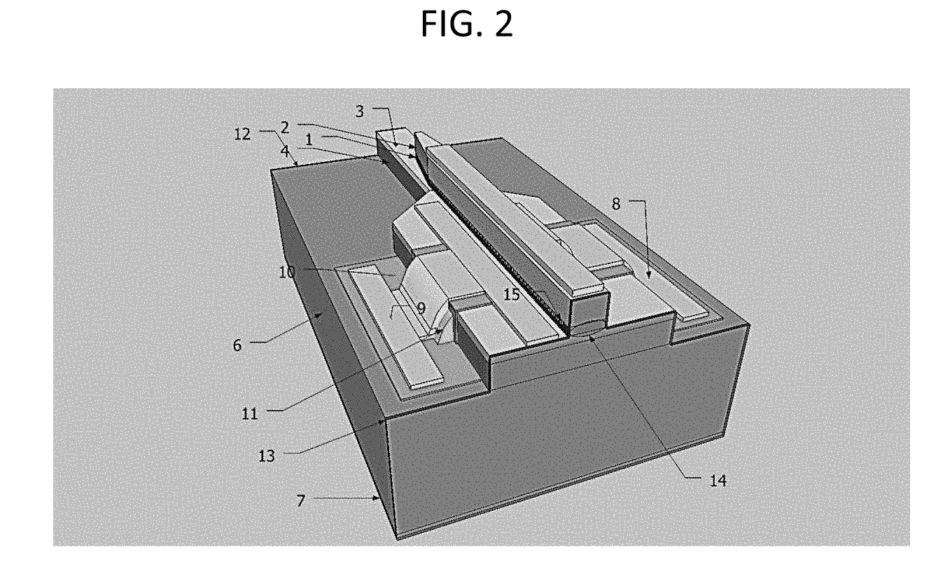

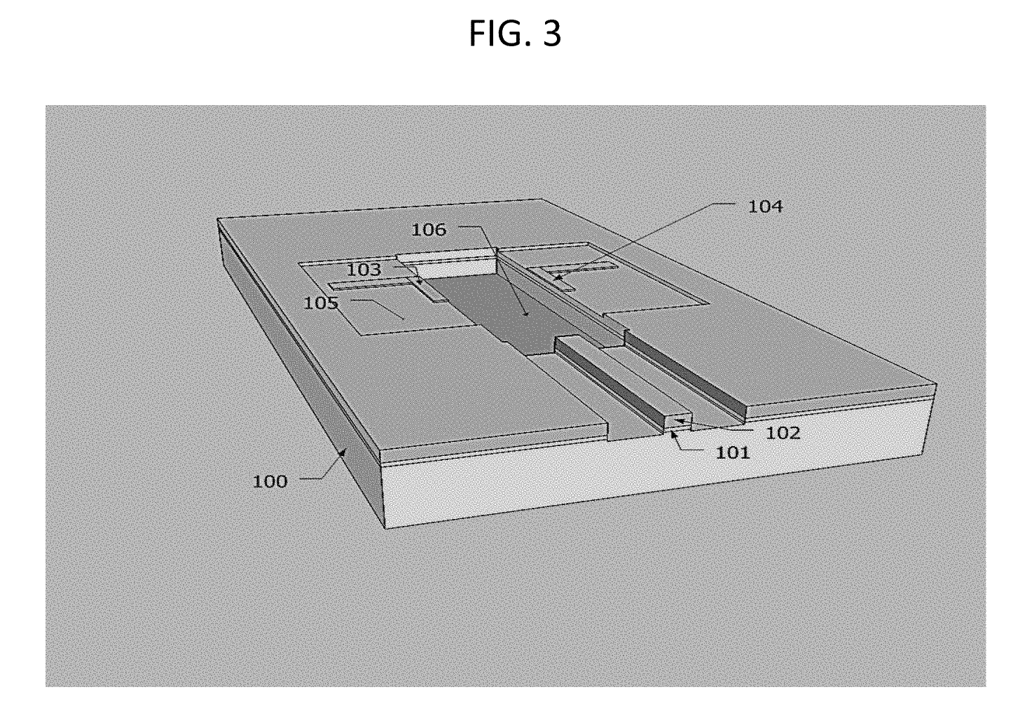

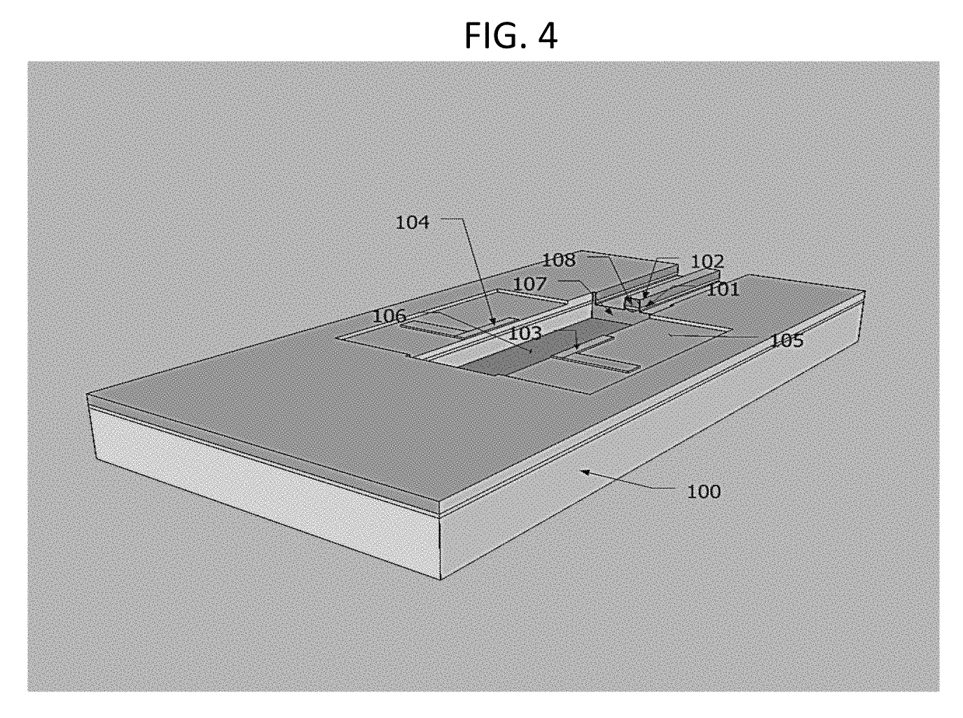

FIGS. 1-9 illustrate the basics of a representative integration scheme, where, as an example, integration of only two PICs is shown. FIGS. 1 and 2 show the front-side 3D view and the back-side 3D view, respectively, of one of the two PICs. This PIC is flip-chip bonded onto the other and thus is referred to as the top PIC. FIGS. 3 and 4 show the front-side 3D view and the back-side 3D view, respectively, of the other PIC, referred to as the bottom PIC.

As an example for the top PIC, FIG. 1 shows a simple schematic of a spot-size converted distributed feedback (DFB) laser. Such a laser, and the rest of the PIC, may be made, for example, in indium phosphide (InP)-based materials containing related ternary and quaternary compound layers, such as, but not limited to, indium gallium arsenide (InGaAs), indium aluminum arsenide (InAlAs), indium gallium arsenide phosphide (InGaAsP), and indium gallium aluminum arsenide (InGaAlAs). Many other material systems and laser types can be utilized as well, and InP-based DFB lasers are simply one example. The active laser waveguide sits on top of the SSC waveguide. They are both defined by plasma etching (such as, but not limited to, RIE, ICP-RIE, CAIBE, and RIBE) or wet chemical etching. A lateral taper is used to couple light from the DFB laser waveguide into the SSC waveguide. The laser diode contains a quantum well (QW) core 1 sandwiched between the p cladding 2 and the n cladding 3. The active core is not limited to QW structures only, and other gain structures, such as quantum dot (QD) and bulk gain structures can be used. The distributed feedback grating 15 sits between the QW laser core 1 and the p cladding 2. The DFB grating can be of many different types, such as, but not limited to, a regular/uniform grating, quarter-wave-shifted grating, or a variable-pitch grating. The SSC waveguide shares n cladding 3 with the laser waveguide, and it contains an SSC core 4, as well as the substrate 6, which is also used as the bottom-side cladding for the SSC waveguide.

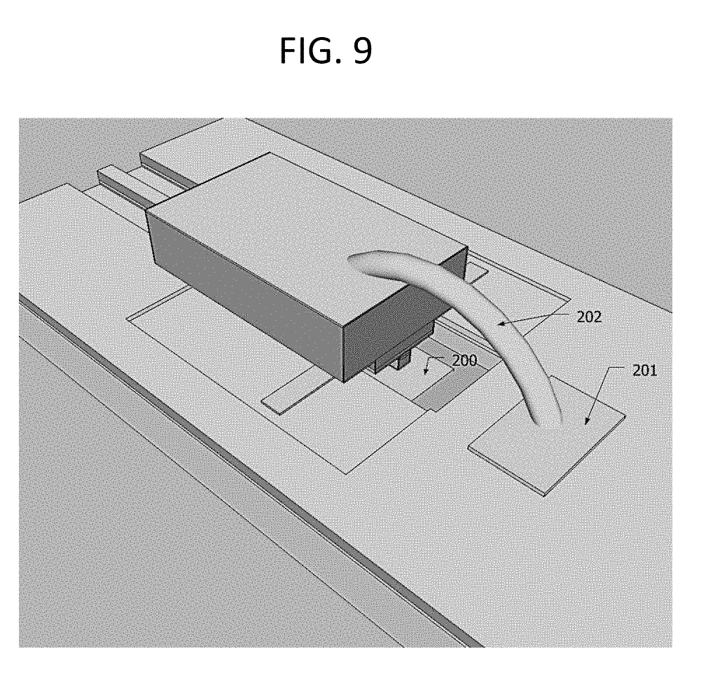

Metal contact pads 8 and 9 are connected to the p and n side of the diode, respectively. A dielectric layer 10, such as silicon dioxide (SiO₂) or silicon nitride (Si₃N₄), sits underneath the metal pads and traces, where necessary, in order to provide electrical isolation. In the figures, for clarity, the dielectric is shown only underneath the metal pads and traces, whereas in typical in PICs, it coats the entire top surface of the PICs as well as waveguide sidewalls. Typically, there may be more than one dielectric layer that is covering the PIC, deposited using PECVD, sputtering, e-beam evaporation, atomic layer deposition, spin-coating, or other techniques. Such a dielectric layer also serves the purpose of passivation of the semiconductor surface. Anisotropic etching of accumulated dielectric can produce features such as a shallow slope 11, which prevents metal discontinuities at sharp semiconductor edges. Other materials, such as photo-definable benzocyclobutene (BCB), can be used for this purpose as well. Backside metallization 7 can be added as well to facilitate additional electrical or thermal contacts (as will be shown in FIG. 9).

In this example, the front facet of the top PIC 12 is anti-reflection coated and the back facet of the top PIC 13 is coated with a dielectric stack or metal that provides high-reflectivity (>90%). The front and back facets can be etched, polished, or cleaved. Not shown in the figure is the fact that the front facet (and/or the back facet) can be “angled” to minimize reflections that may disturb the operation of the laser. If the facets are made by cleaving, the SSC waveguide would be designed to approach the facet at a small angle (<10 deg.). If the SSC facet is dry-etched, than the SSC waveguide may run straight, for example, normal to the major plane, in the same direction in which the DFB laser is oriented, and the SSC facet itself can be etched at an angle relative to the major plane in order to reduce reflections. The side of the top PIC where the SSC etched facet is placed can be cleaved or diced in one direction, while the etched SSC facet sitting on the top of that face of the PIC, sitting slightly inside the PIC relative to the face, can have a slightly different orientation. The angle of the SSC waveguide in the top PIC and the angle of the SSC facet can thus be made so that light leaves the top PIC in the direction normal to the face at which the etched SSC facet is found, which enables collinear butt coupling of the top and the bottom PICs. Another potential benefit of the etched facet is that the quality of the etch defines the optical facet loss, and not the quality of the cleave, dicing, or etch of the corresponding face of the PIC, which alleviates the need for thinning of the substrate. Typically, the substrate would be thinned and then cleaved in order to produce a smooth, low-loss optical facet. Thinning increases cost and decreases PIC yield. Windowing is another technique that can also be used to minimize the reflections, where the “windowing” implies that at the very end of the SSC, there is a free-space region where the light can diverge so that the reflected divergent light (reflected off the facet) does not couple back into the SSC very efficiently, but it still couples efficiently into the bottom PIC. The size of the SSC optical beam 5 is considerably larger than that of the DFB laser 14, which is shown in FIG. 2. The use of the spot-size converted light in this integration scheme significantly improves the coupling of light from one PIC that is attached to another PIC. The vertical coupling and the epitaxial layers that enable it are not shown in great detail here. A more detailed discussion of this and other types of structures will be presented further below.

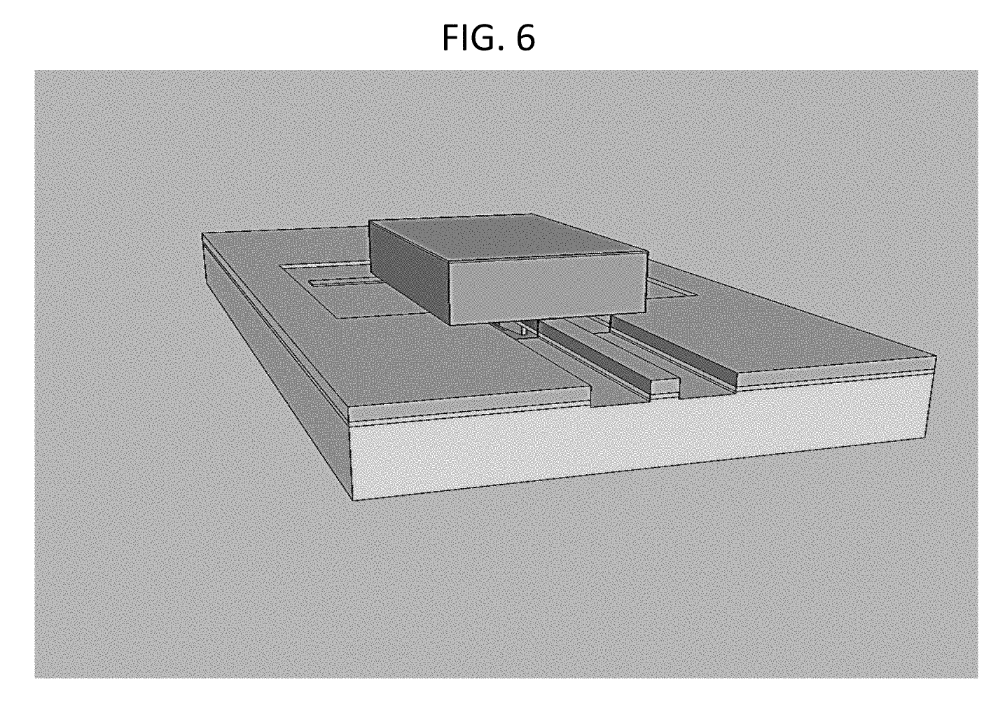

FIG. 3 shows a front-side 3D view of the part of the bottom PIC that is used to facilitate the integration of the top PIC. The rest of the PIC may contain electronic and/or optical circuits, both active and passive. The bottom PIC, similar to the top PIC, can be made of semiconductors, such as, but not limited to, InP, gallium arsenide (GaAs), silicon (Si), as well as glass, and other platforms used for PICs and OEICs. The bottom PIC has a SSC waveguide, which, similar to the one in the top PIC, can be formed by, for example, dry (plasma) or wet etching. It is sitting on the bottom PIC substrate 100. The SSC in the bottom PIC contains symbolic layers 101 and 102, which are shown to illustrate alignment to the corresponding layers 3 and 4 on the top PIC, as will be shown in FIG. 6. The metal pads 103 and 104 are used to bond to the pads 9 and 8 of the top PIC, respectively. The recessed area 106 allows for the top layers of the top PIC to penetrate into the bottom PIC so that the two SSCs align precisely. The recessed area 105 further enables precise alignment as it compensates for the thickness of the metal pads, dielectric passivation layers, and other layers. The depth of the recessed area depends on the exact geometry of both the top and the bottom PICs, and in some cases it may be needed for there to be a pedestal, rather than a recessed feature in order to facilitate precise alignment of the SSCs on the top and the bottom PICs.

FIG. 4 shows the 3D view of the bottom PIC from the backside. Here the bottom PIC SSC facet 107 is shown. This facet cannot be cleaved because it is not at the end of the bottom PIC, but instead could be dry or wet etched. The bottom PIC SSC beam profile 108 is indicated as well, and it is matched to that of the top PIC (beam profile 5).

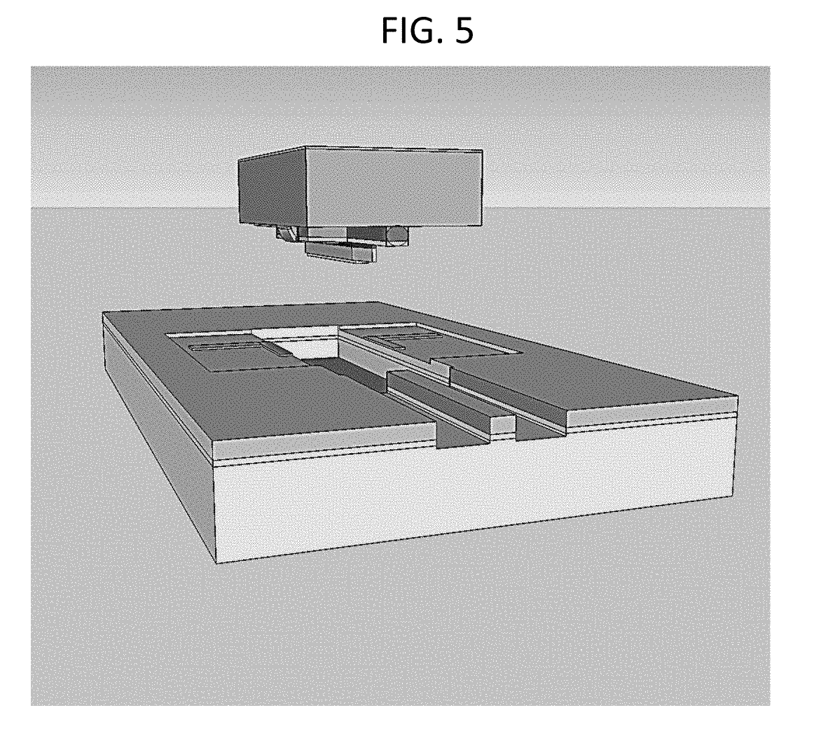

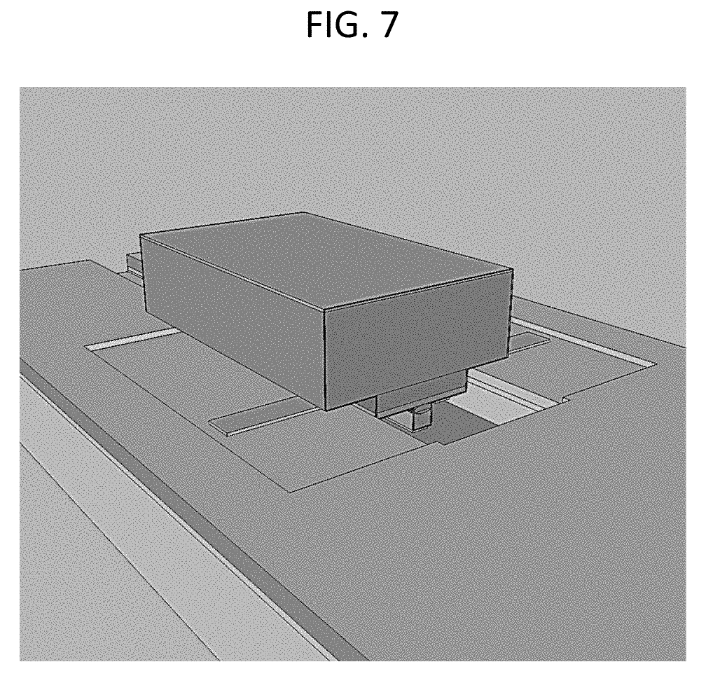

FIG. 5 illustrates the method in which the top PIC is flipped just before attachment to the bottom PIC. The top PIC is shown attached to the bottom PIC in FIG. 6. To illustrate the precise alignment, the top PIC SSC layers 3 and 4 are shown to align precisely with their counterparts 101 and 102 on the bottom PIC. The SSCs in the top and the bottom PIC may be implemented in different materials and technologies, and may not geometrically be similar. The SSCs may not have the layers 3 and 4 or 101 and 102. These layers are used here to guide the eye and visually imply precise alignment, as well as the fact that the top SSC has to match to the bottom one when flipped. By precise alignment between the top and the bottom SSCs, it is meant precise alignment between the corresponding optical beams that minimizes optical insertion loss, i.e., optical coupling between the two chips. Typically, such maximization of the optical transmission between the two SSCs in turn minimizes the optical reflection at the interface between the two SSCs, as well. In order to minimize the insertion loss between the two SSCs, the numerical apertures of the two SSC waveguide have to be small and matched, as well as the overlap of their normalized mode profiles has to be close to 100%. FIG. 7 shows a 3D backside view of the two PICs after bonding.

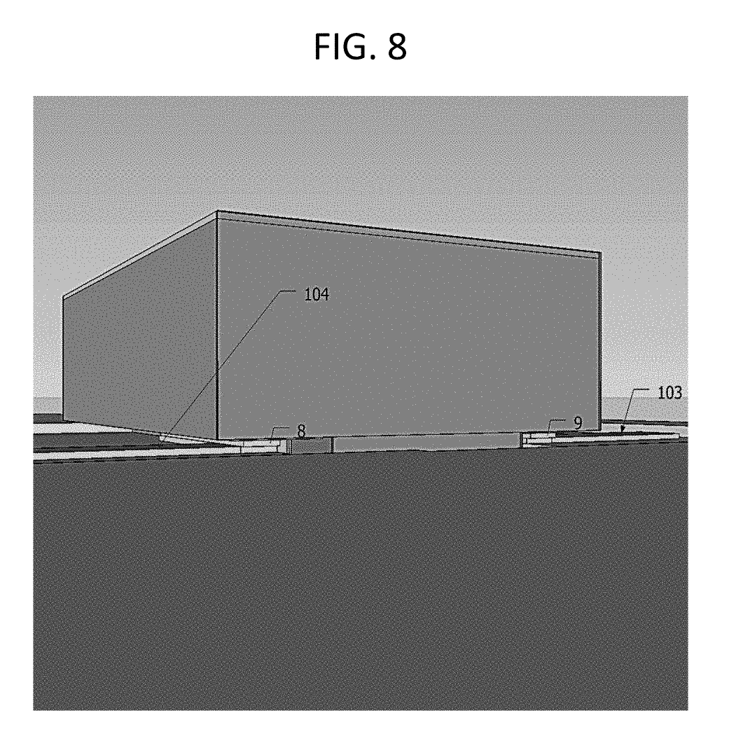

FIG. 8 is a 3D backside view of the two PICs after bonding. This figure indicates that the depth of the etched area 5 is engineered to provide electrical contacts between metal pads 8 and 104 and 9 and 103, while enabling precise alignment between the two SSCs.

FIG. 9 shows that the top PIC backside metallization 7 can be connected to a metal pad (201) on the bottom PIC for additional electrical and/or thermal connection. This connection is not necessary, however, may be incorporated for convenience. The connection can, for example, be made with a wirebond, element 202. One or more wirebonds and/or metal pads on the bottom PIC may be used. If the bottom PIC is an SOI PIC, the pad 201 could be placed on silicon that is underneath the BOX layer, rather than on the silicon waveguide layer that is sitting on top of the BOX layer, in order to improve the thermal conductivity, which is limited by the SiO2 BOX. In other words, in order to improve the thermal conductivity, the top silicon layer and the BOX layer underneath it would be etched in places where the top PIC is touching the bottom PIC for the purpose of thermal management. A similar approach can be applied to the top PIC if it is an SOI PIC. Similarly, if the top or the bottom PICs are not SOI PICs but still have a low-conductivity layer (SiO₂, Si₃N₄, BCB, ternary and quaternary semiconductors, which have lower thermal conductivities compared to binary semiconductors) sitting on the surface where the thermal pad is to be added, the low conductivity layers can be etched off. If these low-thermal-conductivity layers are used for electrical isolation as well, as is usually the case for SiO₂ and Si₃N₄ passivation films, some other means of electrical isolation, such as semiconductor etching or ion implantation can be used as an alternative in the regions where the low-thermal-conductivity layers have been removed.

The metal pad 200 on the bottom PIC can be used for a direct contact to the top electrode of the DFB laser. In this case, the bottom PIC etch 106 cannot be too deep, and it has to have the right depth to allow for the physical contact. If a solder is used for flip-chip bonding, because the solder becomes soft and squeezes in the bonding process, the depth tolerance of the etch 106 is relaxed. The mechanical contact at the bottom of the etched area 106 can be used to improve the heat dissipation without the metal as well because almost any mechanical contact will provide a better thermal conductivity than air would (the atmosphere here would depend on the application and the type of packaging used, which could be hermetic or not). More generally, both the bottom of the etched area 106 as well as the sidewalls, metalized or not, can be used for the thermal management. In one embodiment, the metal pads 8 and 9 on the top PIC can be bonded to the respective metal pads on the bottom PIC 104 and 103 by for example a direct gold-to-gold bonding without solder, that would facilitate a very good control of vertical alignment, while solder or some other type of thermal paste can be used to extract heat from the top of the laser waveguide, i.e., the p-cladding. It is usually more important to extract the heat from the top of the laser ridge than from the bottom of the substrate. If the heat is extracted from both the top and the bottom of a PIC, as implied in FIG. 9, it is important to avoid electrically shorting the p and n sides of the laser diode. In FIGS. 3-9, it is assumed that the bottom PIC SSC waveguide, as well as all the electrical pads/connections, can freely be routed to other relevant connections and circuits. Some of these connections may have to be designed for high-frequency performance, for example in the case where the DFB laser is a directly modulated one, rather than a continuous-wave (CW) laser. The details of the design will also depend whether doped (conductive) or semi-insulating (SI) (non-conductive) substrates are used for the top and/or the bottom PICs.

It is understood that in some cases some etching is required in order to align the SSC facets on the top and the bottom PICs. This depth of this etching has to be at least as large as the characteristic vertical dimension of the SSC facets. By “characteristic vertical dimension” it is meant that it is actually the sizes and the positions of the optical beams that matter more than specific details of the SSC geometry. The SSC on the bottom PIC can sit for example underneath the rest of the circuit, not on top. The same is true for the SSC on the top PIC; it can sit on top of the laser (if it is the laser that is being integrated, not some other device), it can be removed above the laser area, in order to make contact to the laser, but still used for coupling at the edge of the top PIC. If the bottom PIC SSC is below the rest of the circuit, it is understood that the circuit layers will have to be etched in order to create access to the SSC layers. This would constitute an additional etch besides the etch of the area 106. Therefore, in order to facilitate the optical coupling in the integration platform described herein, more than one etch may be necessary in the bottom PIC, and the same is true for the top PIC. In addition, the etched area 106 may have discontinuous walls; it does not have to appear as a hole. In this case, it may be looking as, and actually be, an array of carefully placed pillars/posts. It is possible to have a combination of holes with solid walls and pillars. Similar to typical flip-chip bonding, pillars, posts, and etched holes may be distributed over an area much wider than the size of the SSCs in order to facilitate better leveling of the top PIC. The distribution, size, and the number of these alignment features depend on the size and the topography of the top PIC, as well as the bottom PIC. These posts may be of varying heights and some of them may be used as stop features used to prevent excessive movement in vertical as well as horizontal dimensions during bonding, which in turns improves the alignment accuracy.

FIG. 6 implies that the top PIC is butt coupled to the bottom PIC. It implies that the two SSCs are touching. This is one of the embodiments that can be implemented. A typical UV-curable epoxy can also be applied between the two facets, as well as other index-matching materials. However, the two facets (12 and 108) do not have to touch and the integration approach tolerates quite large (10 s of micrometers) separation between the two because the large beams of the SSCs typically diverge very slowly, i.e., the SSCs have low numerical apertures. This improves the alignment tolerances between the two SSC waveguides in the longitudinal direction compared to a similar integration approach that does not use big SSC beams. Similarly, the large beam size is crucial for the alignment tolerance in the other two, transverse, vertical and horizontal directions. With modern flip-chip bonding tools, it is possible to align two devices, such as two SSC waveguides described here, with an accuracy of ˜0.5 μm. A typical DFB laser has a comparable mode size in the vertical direction which means that if a modern flip-chip bonder or a similar tool is used to align two DFB-laser type of waveguides, instead of two considerably larger SSC waveguides, the success rate or yield, would be very low. The two SSCs can be made to have beam sizes larger than 5 μm, or as large as the mode-field diameter of a single mode fiber. In this case the flip-chip bonder alignment accuracy of ˜0.5 μm becomes small in relation to the physical size of the SSC beam. This would allow for using less precise flip-chip bonders to save on cost. The large beam sizes of the SSCs make them also robust to the misalignment that stems from the variation in thicknesses and refractive indices of the constituent epitaxial layers. The SSC facet 107 of the bottom PIC, may be anti-reflection coated, similar to the SSC facet 12 of the top PIC. However, for the bottom facet, this may be harder to do because the facet is not at the edge of the PIC, so that the anti-reflection coated film cannot be deposited or sputtered directly onto the surface of the facet, in the direction normal to it. Although this kind of coating is possible, the integration approach described in this document allows for this facet not to be coated at all. The large beam sizes of the SSCs typically require either much smaller facet angles (1-3 deg. instead of 7-10 deg. when compared to the regular, smaller waveguides) to be used in combination with anti-reflection coating, or, if the angles are kept large, the large beam size allows the angled SSC facets to eliminate the parasitic reflection even if the addition anti-reflection coating is not used. Increasing the size of the SSC facet, without changing the angle, increases the phase variation across the cross-section of the reflected light normal to the direction of propagation, and in turn decreased the efficiency of coupling back into the SSC waveguide. If index-matching material is used between the two SSC facets, the need for anti-reflection coating in the bottom PIC is further minimized. The SSC facets of either the top PIC or the bottom PIC, or both, may be angled and/or anti-reflection coated.

Another benefit of the large beam size in SSCs is that the light diverges slowly, and if “windowing” is used as a mechanism to prevent parasitic facet reflections, the free-propagating region is large and thus tolerant to small size variations that come from fabrication, as well as the epitaxial growth. For example, since it is not easy to precisely control the position of the cleaved facet (the position of the etched facet is better controlled), the length of the free space region is better controlled when the light diverges slowly, i.e., the length will suffer a smaller percent change due to the uncertainty of the facet position.

The top PIC can have an additional port, on the back side, that is also coupled to the bottom PIC, instead of having only one coupling port on one side, as shown in FIGS. 1 and 2. Such a top PIC would look more symmetric. Both of the top facets can be etched or even cleaved. Cleaving introduces uncertainty in the length of the top PIC (in the separation between the two facets of the top PIC) but as long as the separation between the two corresponding SSC facets in the bottom PIC is made large enough, this is not a problem due to the large longitudinal alignment tolerance stemming from the small SSC beam divergence. For example, the symmetric arrangement is of interest in DFB laser sources that output light from both side, which could be used in spatial division multiplexing applications (for example, 100G, or faster, Ethernet). Such a laser does not have a reflector and can be made to be less susceptible to the single-mode yield issue compared to the case of a single-ended laser using a uniform DFB grating. The double-sided configuration also works naturally when the top PIC is based on circuits containing two-port devices, such as (spot-size converted) semiconductor optical amplifiers (SOAs), optical modulators, two-mirror distributed Bragg reflector (DBR) lasers (with mirrors on either the top or the bottom PIC), and others. Instead of being co-linear and on the opposite sides of the PIC, the two facet of the device can also be arranged to be next to each other on the same side of the PIC. Such routing of light can be achieved using, for example, curved waveguides or etched mirror reflectors. Having two facet on the same side improved the alignment tolerance, especially in the longitudinal direction, at the expense of the optical loss that arises from the addition routing.

If the circuit in the top PIC contains a light splitting or multiplexing/de-multiplexing element, such as a multi-mode interference filter (MMI), arrayed-waveguide grating (AWG), echelle grating, and others, the top PIC may have more than 2 ports. This integration scheme allows for seamless integration of such a multi-port top PIC to a multi-port bottom PIC. The multi-port devices may be arrays of independent devices. In the dual-port and the multi-port integration, the SSC facets that are used to mate the top PIC and the bottom PIC do not have to be co-linear, but can be arranged to exit on any or all sides of the top and the bottom PICs. The top PIC may contain a photonic circuit that has multiple ports, oriented in multiple directions, where these ports would be etched, rather than cleaved, and they may mate with their counterparts in the bottom PIC. This would look like a distributed interleaving/infusing of the top and the bottom PICs. The integration allows for various bonding schemes: a single top device to a single bottom device, a multi-port device to a multi-port device, and array to an array, etc. The integration approach, allows for chip-to-chip as well as wafer scale integration. Both passive and active alignments may be possible with the integration approach described herein.

The top PIC can contain more than one active device. Instead of containing a single, for example, spot-size-converted laser, SOA, or photodetector, the top PIC may contain a spot-size converted electro-absorption modulated laser (EML). For wavelength-division-multiplexed (WDM) sources/transmitters, it is difficult to monolithically integrate, 4 or more lasers that emit light into channels separated by ˜20 nm. This is because typical optical gain bandwidth in the most popular gain material, i.e., QWs, does not span the 60 nm needed for the 4 channels, and this is especially true if there are more channels separated so widely in wavelength. Such wide separation is required for uncooled coarse WDM (CWD) applications, such as 40G Ethernet application. However, with the integration approach described in this document, it is easy to flip-chip bond lasers made from different gain materials onto the same bottom PIC that may contain the multiplexing optical circuit, as well as the electronics. In addition, the monolithic integration of the photonics and the electronics for similar applications, e.g., integration of a CWDM 4 channel optical EML transmitter (having 25 Gbps channel speeds) with the laser and modulator drivers, is not easy because the active optical and active electronic layers may interact. For example, there may be huge parasitic capacitance seen by the transistors that comes from the doped laser or modulator layers. In the integration scheme disclosed herein, all the active optical components, for example, can be made in the top PIC, and the bottom PIC may contain all the electronics and only the passive optical waveguides and multiplexing devices, which are not expected to interfere with the electronics to the same extent that the active photonic devices are. It is not easy to monolithically integrate a laser and an electroabsorption modulator either. If the EML were to be integrated with some passive (e.g., multiplexing) optics and electronics, it may be easier to make the top chip as a spot-size converted laser only, without the modulator, and monolithically integrate the modulator with the passive optics and the electronics on the bottom chip. The disclosed integration platform allows for this additional degree of freedom so that the compatible components are integrated monolithically on either chip and the two chips are simply flip-chipped together (in the various ways described herein).

To better motivate the disclosed integration approach and its use of SSCs, the following should be emphasized. The long-haul optical communications have traditionally been the dominant market for PICs and optical components. The long-haul communications require components that have high quality but that are produced in small volumes and thus are quite expensive. Consequently, typical coupling between a PIC and an optical fiber, in a package, would be not through an integrated SSC, but miniature-bulk optics, such as lenses would be used in packaging. A laser output facet, for example, would be formed in the laser waveguide, without monolithic or non-monolithic on-chip mode conversion. This expensive optical coupling scheme was tolerated because of the high-cost of the components. Today, there is an ever-increasing pressure to decrease the price of PICs and optical components, driven by the applications such as data center interconnects (100G Ethernet, terabit Ethernet) and metro coherent networks. The pressure is on the integrated photonics to become commodity. Integrated SSC will become very important for these new large-volume applications. Although, various types of the SSCs have been studied and demonstrated (mainly in the academic circuits) going back more than two decades, they are not yet fully commercialized and present in commercial PICs, even those targeting the high-volume applications. In not-to-distant future, many vendors will produce spot-size converted PICs, and many foundries will have the capability and know-how to offer them as building blocks for the PICs that they make. The disclosed integration platform presented will benefit greatly from the commercialization of the SSCs.

There are several ways to integrate SSCs with PICs in order in the disclosed integration platform. Below, some of these technologies are reviewed and summarized to provide examples.

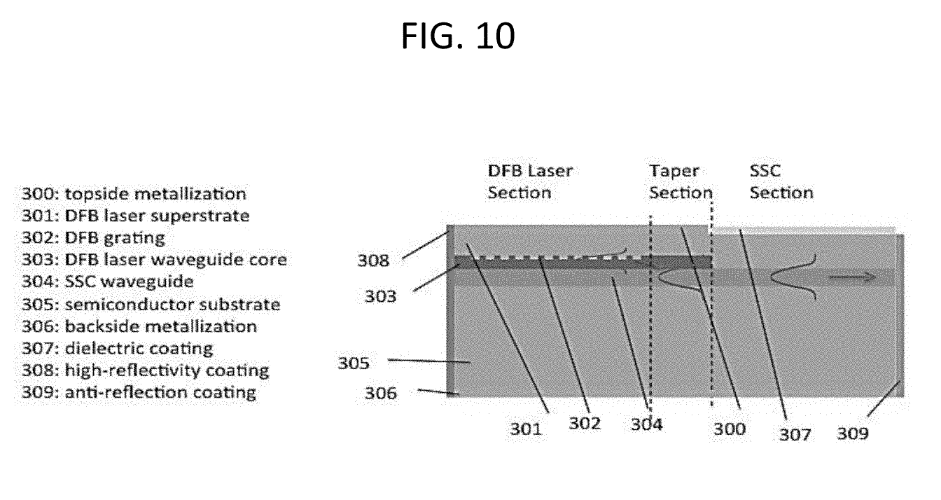

FIG. 10 shows a side-view cross-section of a spot-size converted device implied in FIGS. 1 and 2. The emphasis in FIG. 10 is on the specific type of the optical coupling implemented for the spot-size converted device. In this type of SSC, the light is coupled vertically between the DFB laser and the SSC. In order to squeeze light out of the DFB laser waveguide, a lateral taper is used, which is better illustrated in FIGS. 1 and 2. In FIG. 10, a small laser mode is generated in the “DFB Laser Section”. The small laser mode is then coupled into a bigger SSC mode in the later taper (The tapering cannot be seen in this cross-sectional view of FIG. 10- it is better illustrated in FIGS. 1 and 2.) of the “Taper Section”. The large SSC mode propagates through the “SSC Section” and leaves the PIC at the anti-reflection coated facet. This kind of vertical light coupling and monolithically integrated spot-size converted devices are described in, for example, V. Vusirikala, et.al., IEEE Journal of Selected Topics in Quantum Electronics, vol. 3, no. 6, pp. 1332-1343, December 1997, F. Xia, et. al., IEEE Journal of Selected Topics in Quantum Electronics, vol. 11, no. 1, pp. 17-29, January/February 2005, V. M. Menon, et. al., IEEE Journal of Selected Topics in Quantum Electronics, vol. 11, no. 1, pp. 30-42, January/February 2005, F. Xia, et. al., IEEE Photonics Technology Letters, vol. 13, no. 8, pp. 845-847, August 2001, S. Ristic et al, Proc. OSA Conf. on Int. Photon. Research, Silicon and Nano-Photonics (IPR), IW5A.6. Rio Grande, Puerto Rico (2013), F.-Z. Lin, et. al., Optics Express, vol. 16, no. 11, pp. 7588-7594, May 2008, all of which are incorporated herein by reference. The actual design of the SSC waveguide can vary, as it does in the given references. For example, to provide a big mode, the core of the waveguide can be made big, and only slightly different in refractive index from the surrounding cladding in order to avoid multimoding. In the AlGaAs/GaAs systems it is relatively easy to grow thick ternary cores without creating epitaxial strain issues. In the InGaAsP/InP material system, in order to avoid the strain issues, it is typical to form the core by interleaving very thin layers of higher-index material with InP. The refractive index of the thin layers provides an average refractive index of the core that is slightly larger than that of InP and in turn provides for a large single-mode SSC waveguide.

Although the lateral taper can also start in the “DFB Laser Section,” in FIG. 10, it is implied that the tapering is limited only to the “Taper Section. Thus the “Taper Section” does not contain the grating and does not contribute to lasing. If not pumped, the active core in the “Taper Section” would create great optical loss due to interband absorption. Consequently, in FIG. 10, the “Taper Section” is metalized, and pumped above transparency to reduce the optical losses. It basically forms a semiconductor optical amplifier (SOA). The top p-metal electrode in the “Taper Section” can be electrically isolated from the “DFB Laser Section” by semiconductor etching or ion implantation, which would provide independent biasing in the two sections. Alternatively, in order to minimize the interband absorption, the “Taper Section” can be intermixed. In addition, the p-cladding in the “Taper Section”, as well as the “SSC Section” can be implanted with protons in order to reduce the intervalence band absorption (IVBA), or a cladding without p-doping may be regrown in these sections.

Other methods of reducing optical losses in PICs such as disclosed in S. Ristic, et. al., Journal of Lightwave Technology, vol. 28, no. 4, pp. 526-538, February 2010, and L. A. Coldren, Journal of Lightwave Technology, vol. 29, no. 4, pp. 554-570, February 2011 can be used.

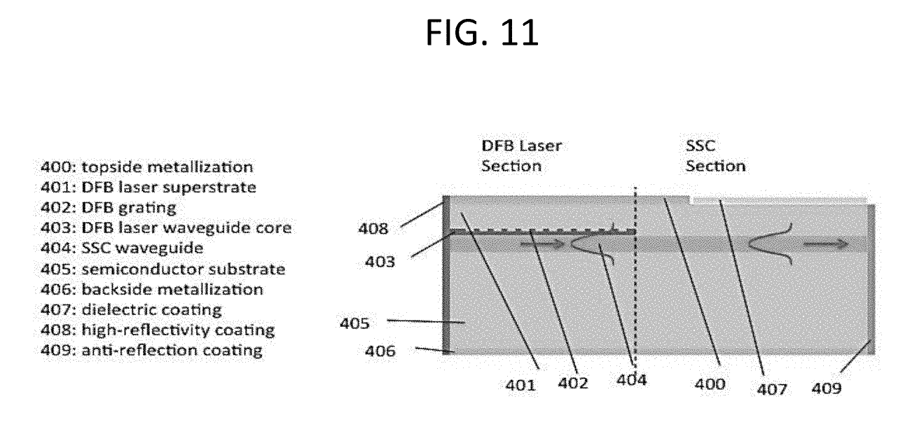

FIG. 11 shows an alternative way to integrate a SSC with a device such as DFB laser. Here, the laser core is not thick enough to support a mode. The mode in the “DFB Laser Section” is actually that of the underlying passive waveguide evanescently coupled to the laser waveguide core that provides gain. The passive waveguide can be designed to have a large mode and thus act as an SSC waveguide. This type of SSC can be used with for an edge-coupled photodetector. Evanescent coupling has also been used as the mechanism of vertical integration, although not demonstrated for integration of the SSC per se.

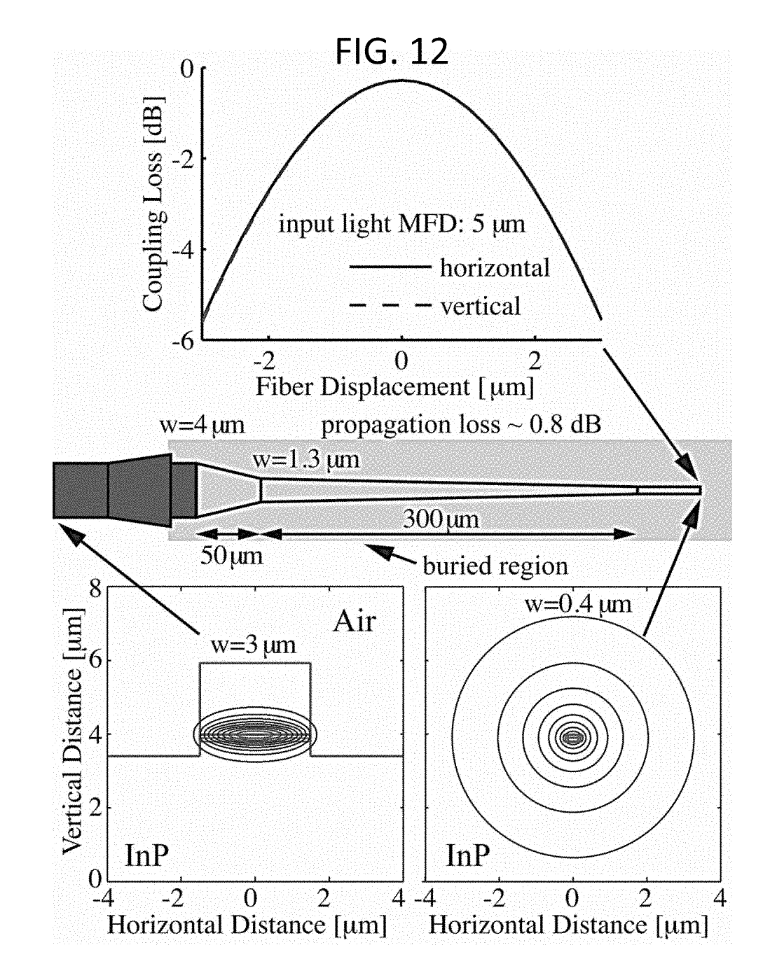

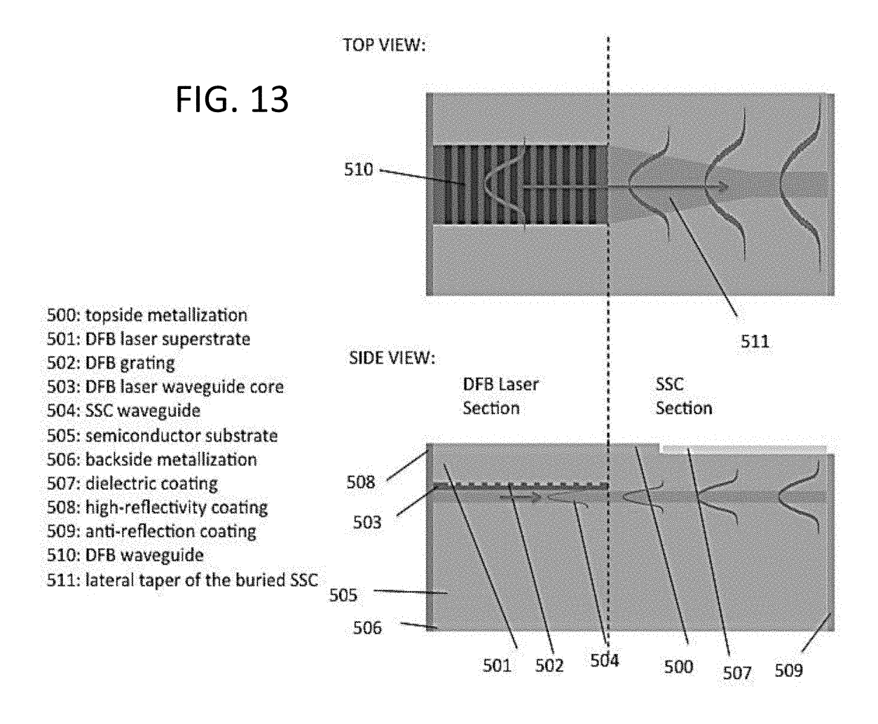

Another scheme to produce SSC does not involve vertical coupling of light. Rather, this scheme exploits the fact that if the core of a waveguide is tapered laterally (and/or vertically, as explained bellow), and if the core is buried in a thick semiconductor cladding material (using for example selective area growth), it is possible to form a buried type of waveguide with a very thin core. This core is too thin to confine the half-wavelength type of lateral resonance that is typical of the waveguide modes, but still the core acts as a center of a big optical spot, and can be used a quite an efficient SSC (see S. Ristic, et. al., Journal of Lightwave Technology, vol. 28, no. 4, pp. 526-538, Feb. 2010, M. Kohtoku,. et. al., Journal of Lightwave Technology, vol. 23, no. 12, pp. 4207-4214, December 2005, and K. Kasaya, et. al., IEEE Photonics Technology Letters, vol. 5, no. 3, pp. 345-347, March 1993). This type of SSC is illustrated in FIG. 12 and FIG. 13. In FIG. 12, numerical simulations show how a small, elliptical laser mode can be converted into a large, circular SSC mode. In SOI PICs, a similar scheme has been demonstrated, where the core is buried in polymer instead of semiconductor cladding. This approach can be combined with quantum-well intermixing in order to minimize the optical loss of active core that is also acting as a SSC buried type of waveguide. This approach can be applied to a passive core that is sitting underneath the active core, and the coupling between the two is implemented using one of the schemes presented in FIGS. 10 and 11.

Although, harder to do, the core of a waveguide can also be tapered vertically, rather than laterally, using a shadow-mask or vertical etching using etch-stop layers. (See L. Hou, et. al., IEEE Photonics Technology Letters, vol. 19, no. 10, pp. 756-758, May 2007, K. Maru, et. al., Electronics Letters, vol. 42, no. 4, pp. 219-220, February 2006, and R. S. Balmer, et. al., Journal of Lightwave Technology, vol. 21, no. 1, pp. 211-217, January 2003.)

The lateral and vertical tapering can be combined in order to implement shorter, and lower loss tapers.

As already mentioned above, it is possible to combine two or more of the presented SSC implementations. For example, evanescent coupling could be used between a DFB laser and an underlying passive waveguide that has a larger mode. Then, the mode of the passive waveguide can be squeezed by a lateral taper into the SSC waveguide that has an even larger mode. This incremental increase of the mode size may prove to be more feasible (e.g., have smaller optical loss) than either of the evanescent or the lateral coupling schemes used alone. Typically, vertical coupling between very dissimilar waveguide cores (dissimilar in the refractive index and consequently the mode size) is not easy to implement and may require long waveguide tapers.

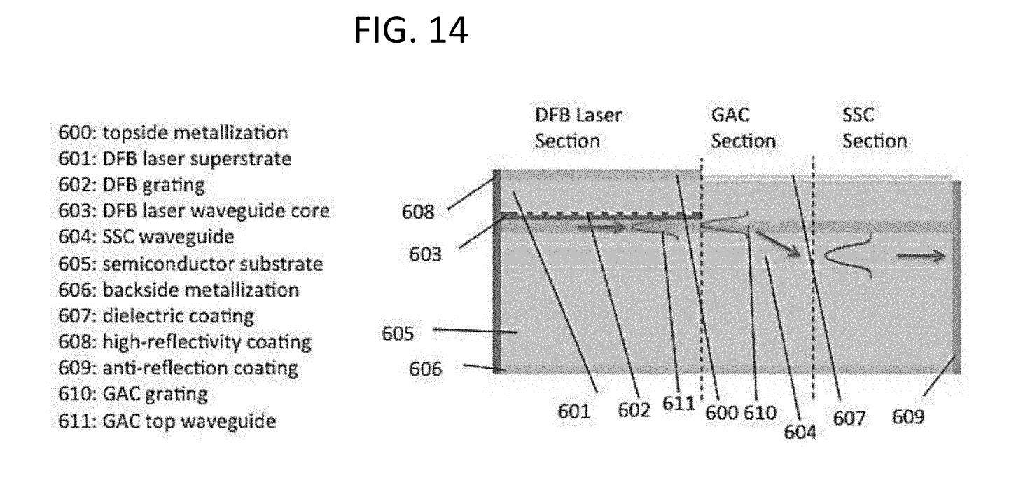

Grating-assisted coupling (GAC) can be used to improve coupling between two dissimilar waveguide cores and can be used to relax the need for intermediate waveguide cores and incremental increase of mode size. FIG. 14 illustrates this method. The grating used in this scheme also acts as a wavelength filter and thus may offer this additional functionally to the PIC.

Various silicon-photonics SSC technologies can be used such as those disclosed in S. J. McNab, et. al., Optics Express, vol. 11, no. 22, pp. 2927-2939, Oct. 2003, T. Shoji, et. al., Electronics Letters, vol. 38, no. 25, pp. 1610-1611, December 2002, and D. C. Lee, et. al., in Proc. Photon. Soc. Summer Top. Meeting, Playa del Carmen, TuD3.3, July 2010, pp. 215-216, J. V. Galan, et. al., Optics Express, vol. 15, no. 11, pp. 7058-7065, May 2007, S. Romero-Garcia, et. al., IEEE Journal of Selected Topics in Quantum Electronics, vol. 20, no. 4, pp. 1-10, July/August 2014. B. Mersali, et. al., IEEE Journal of Selected Topics in Quantum Electronics, vol. 3, no. 6, pp. 1321-1331, December 1997, all of which are incorporated herein by reference. Si-based PICs are of frequently if interest due to their potential for high-volume, low-cost fabrication and integration with CMOS electronics.

SSCs can be provided without monolithic integration. GRIN lenses can be simply epoxied to the facets of the waveguide on either the top or the bottom PIC, or both. The lens system attached to the PIC can have both beam expansion and collimation functionalities. However, if the lens is such that it lacks the beam expansion functionality, this can be done on the chip. A simple way to do this would be to terminate the waveguide and allow the beam to propagate in free-space region achieved by etching a slot. The beam starts diverging when it enters the slot. This sidewall of the slot can be AR coated, as well as the other sidewall of the slot. The lens is mechanically supported by the other wall of the slot. The slot can be filled with dielectric, polymer, and similar material. Also, the mode expansion region can be made from regrown semiconductor.

In summary, SSCs can be provided in various shapes and sizes, and they can be based on several different waveguide-coupling mechanisms. Although this is not a complete list, the typical optical waveguides that SSCs are coupled to are usually referred to as: ridge, rib, strip, stripe, buried ridge, buried stripe, buried channel, photonic crystal, slot, or polymer waveguide. The SSCs are referred to by different names, where the most common ones are: a lateral down-tapered buried waveguide, a lateral up-tapered buried waveguide, a single lateral taper transition from a ridge waveguide to a grating coupler-matched waveguide, a multi-section taper transition from a ridge waveguide to a grating coupler-matched waveguide, a dual lateral overlapping buried waveguide taper, a dual lateral overlapping ridge waveguide taper, a nested taper transition from a ridge waveguide to a grating coupler-matched waveguide, a vertical down-tapered buried waveguide, a vertical down-tapered ridge waveguide, a vertical overlapping ridge waveguide taper, a vertical overlapping waveguide taper transition from a buried waveguide to a grating coupler-matched waveguide, a vertical overlapping waveguide taper transition from a ridge waveguide to a grating coupler-matched waveguide, a combined lateral and vertical ridge waveguide taper, a 2-D overlapping waveguide transition from a buried waveguide to a grating coupler-matched waveguide, and an overlapping waveguide taper transition with two sections from a ridge waveguide to a grating coupler-matched waveguide.

What is common to these SSCs is they are typically designed in order to minimize the optical insertion loss and reflections when an optical fiber is coupled to a photonic chip. When added to a photonic chip, a SSC achieves this by match the size, shape, and divergence (or numerical aperture) of the optical beam coupled to and from the fiber. The use of SSCs in the present invention is similar to this, where the main difference is that the coupling is not between a spot-size-converted photonic chip and a fiber, but rather (at least) two spot-size converted photonic chips. The present invention includes all of the SSCs listed above and included in the publication references. In addition, the SSCs included in the present invention are defined in a broader sense, including a region needed for “windowing.” As explained above, windowing is a technique that can be used to minimize the reflections, where the “windowing” implies that at the very end of the SSC, there is a free-space region (e.g., in the air, bulk semiconductor, etc.) where the light is not confined to a waveguide (SSC waveguide) and can diverge so that the reflected divergent light (reflected off the facet) does not couple back into the SSC waveguide very efficiently, but it still couples efficiently into the attached PIC.

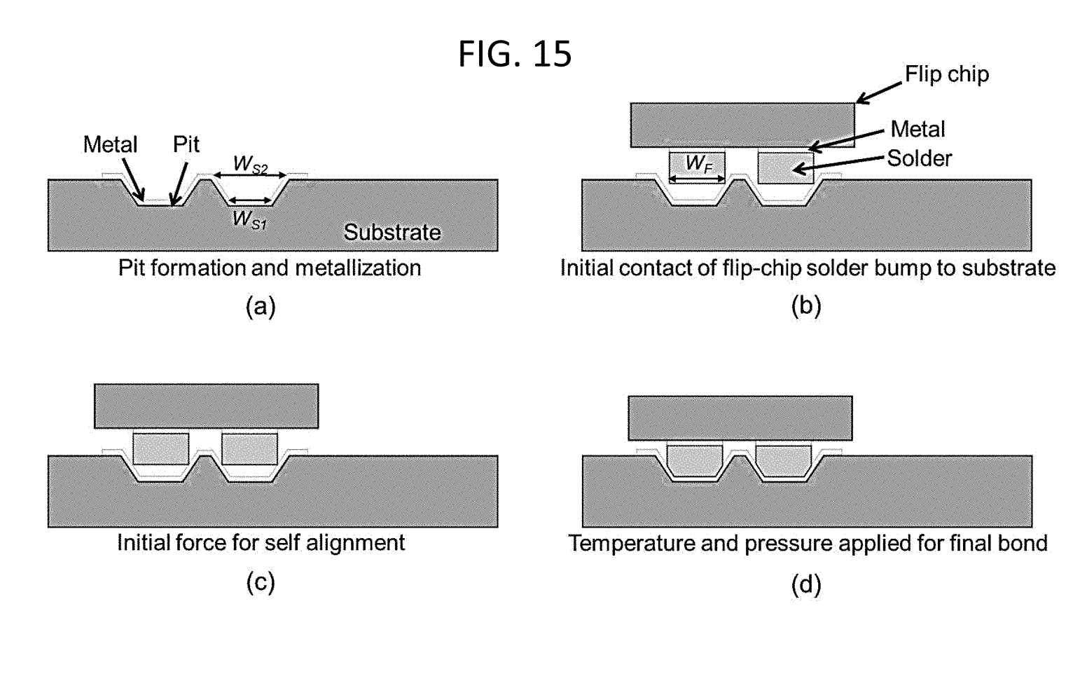

For any embodiment of this invention, and any invention employing flip-chip bonding, a method can be employed to increase the alignment accuracy, which would increase the coupling efficiency from one waveguide to another, as shown in FIG. 15. A pit (or recess) is formed in the substrate with angled sidewalls. A metallization step is then carried out to apply a metal film inside the pit and on the sidewalls. The flip chip (the chip to be bonded to the substrate) has a planar metal film deposited and a solder metal that is sized to fit inside the pit of the substrate. The width of the top of the solder bump, W_{F}, is greater than the width at the base of the pit, W_{S1}, but smaller than the width at the top of the pit, W_{S2}. Therefore when the flip chip is brought into contact with the substrate, contact is made with the angled sidewalls. A small initial force is applied to more precisely align the chips. Then force and temperature are applied to reflow the solder and bond the chips. The solder material will reflow inside the pit. This process thereby allows for some self-alignment of the two chips. The alignment accuracy is high and this allows for using a flip-chip bonding tool with less alignment accuracy in that the final alignment is improved by the mechanics of the ‘self-aligning’ bonding process. If the base substrate is Si, micromachining techniques can be utilized for forming the pits/recesses. For example, using specific potassium hydroxide (KOH) or Tetramethylammonium hydroxide (TMAH) etching techniques, a precisely defined pit with angled sidewalls and a flat base can be formed. Otherwise RIE etching, and several other techniques, could be utilized to form the pit with angled sidewalls. This self-alignment method also works with other, non-solder approaches, such as gold-to-gold ultrasonic bonding. Furthermore, non-metals can be used, both for the pits and for the posts that slide down the angled walls of the pits. The post can be made of semiconductor, dielectric, polymer, or some other similar material, where epoxy is placed on top of the post. Similar to FIG. 15(d), once the post slides down the angled sidewalls, heat, temperature, UV light and similar triggers can be used to promote bonding of the reflowed epoxy to the bottom and the side walls of the pit.

Similarly, if W_{F} is made smaller than or equal to W_{S1}, this self-alignment method employing slanted sidewalls can be used in all bonding techniques of interest for the present invention, including, but not limited to, flip-chip bonding, metal-to-metal thermocompression bonding, solder bonding, ultrasonic bonding, direct bonding (with or without an interfacial layer), or adhesive bonding. If W_{F} is made smaller than or equal to W_{S1}, the hard, top pad will slide down, until the narrowest point of the pit, i.e., the bottom of the pit. Then, the bonding can be performed. Here, the metallization of the sidewalls is not necessary, and metallization is not used at all, of course, in the case of direct or adhesive bonding. The perturbations on the top flip-chip PIC, which penetrate the pits, can be fabricated in different ways. For example, they can be made of metal covered with solder, as shown in FIG. 15, or they can be just thick metal, in the case when solder-less, thermocompression bonding or ultrasonic bonding is used. For other bonding schemes, for example, these perturbations can be made of, for example, polymer, dielectric, semiconductor, or semiconductor covered with dielectric need for bonding. Such posts can be defined by dielectric growth/deposition and etching, semiconductor etching, and the combination of those. Similarly, such post can be defined underneath metal pads when metal bonding is used. The alignment accuracy in this flavor of self-alignment is determined by the size difference between WF and W_{S1}, which means it can be controlled to be much smaller than 0.5 micrometers. Self-alignment allows for accurate, but also fast bonding.

The use of metal pads for solder bonding or solder-less thermocompression bonding, implied throughout this document is given as an example only. The invention presented here includes other type of bonding, such as direct wafer bonding, adhesive bonding, and others. The choice of bonding will depend on the specific application of the invention and the related cost effectiveness, will depend on the type of devices bonded and the required specifications, and will depend on a variety of other factors. As an example, in the applications where the bonding interface between the top PIC and the bottom PIC does not have to be electrically or thermally conductive, as is the case in bonding of passive devices, it may be preferential to use non-metal bonding schemes, such as direct wafer bonding.

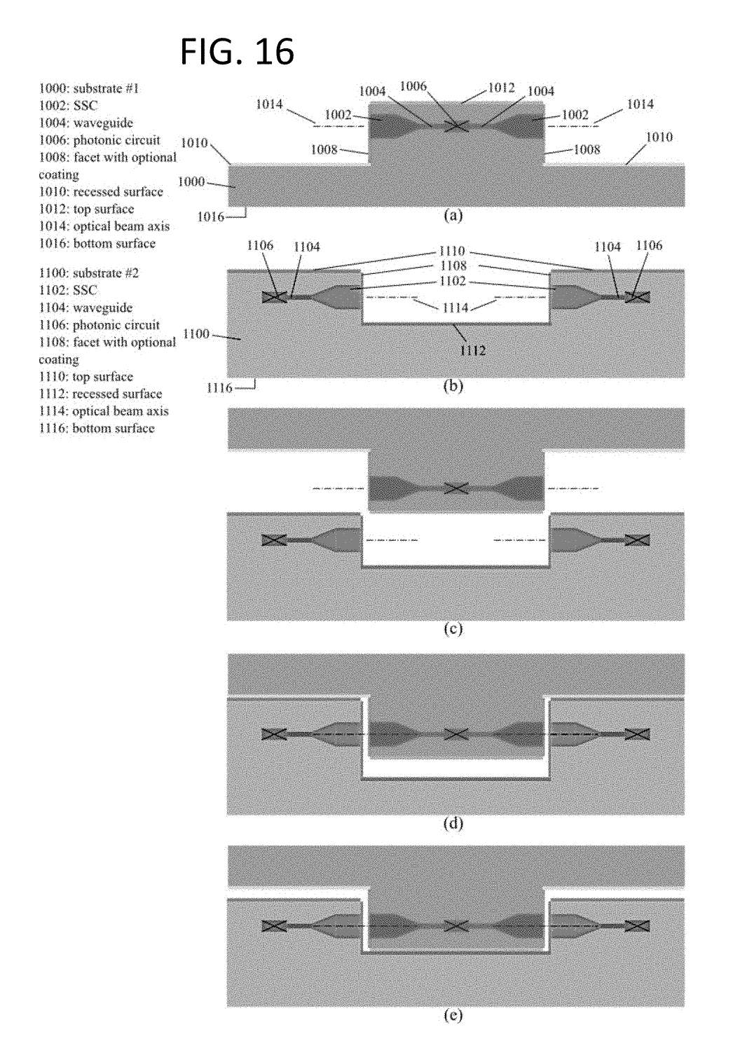

In FIG. 8, it is shown that the bonding pads/areas are on the sides of the optical beam propagation axis corresponding to the light coupled between the two PICs. This bonding pad arrangement is compatible with all the bonding schemes of interest, including but not limited to: metal-to-metal bonding, direct molecular bonding, adhesive bonding, and bonding with an interfacial layer. Another, alternative bonding pad arrangement and positioning that is compatible with all the bonding schemes is shown in FIG. 16. FIGS. 16(a) and 16 (b) show the two substrates (cross-sectional side-views) prepared to be attached to each other and optically coupled. Substrate #1 (1000) in FIG. 16 (a) contains 2 SSCs (1002), each connected with an optical waveguide (1004) to a photonic circuit (1006). There are at least two surfaces that can be used for attachment to another substrate: top surface (1012) and recessed surface (1010). Unlike the embodiment illustrated in FIG. 8, here, the recessed surface is not on the sides of the SSCs but rather in front of them, where, the SSC facets (1008) having optional coating are etched rather than cleaved. The substrate here is assumed to be monolithically integrated, and the facets can only be cleaved when positioned at the substrate outer edges, facing outwards. Below, another embodiment is presented where heterogeneous integration allows the facets to be cleaved even when not at the outer edges of the substrate. FIG. 16(a) also illustrates the direction of light entering or leaving the facets, and this direction is represented by optical beam axis (1014). The axis intercepts the chip at its edge rather than through any of its horizontal planes, such as top surface (1012), recessed surface (1010) or its bottom surface (1016), as to constitute what is termed here as edge coupling, rather than surface coupling. The optical beam axis is not necessarily normal to the plane of the facet, and facet is not necessary vertical. The facet can be tilted vertically or sideways (or both) to minimize the effect of the reflections.

Here, it should be noted that in addition to the facet tilting in order to minimize the reflections, the orientation of the facet can be adjusted to direct the optical beam in the desired direction when exiting the substrate, or to accept an incoming beam from a predetermined direction, where the direction can have both a horizontal and vertical angles with respect to the substrate. Also, the facet can be anti-reflection coated as it was shown in some of the example embodiments described in the figures preceding FIG. 16. The same is true for the embodiment shown in FIG. 16. However, it is also possible that the facet coating is designed to provide some wavelength, polarization, or other filtering function. The facet can be coated to provide a partial reflection, or even an almost-complete reflection as well. A reflecting facet could, for example, together with the SSC, be used to form a laser resonant cavity. For example, in the case of almost complete reflection, the corresponding large-profile mode reflected of such a high-reflection-coated facet would have small divergence, and, thus, it would be easy to design and fabricate facet's high-reflection coating. On the other hand, if a large-profile facet were used to provide a partial reflection as a, for example, output facet of the laser, it would facilitate the output coupling of the device. In the reset of the document, the facets will be referred to as optionally coated facets, and it is understood that the facets are not necessarily only anti-reflection coated.

FIG. 16(b) shows substrate #2 (1100), two coupling SSCs (1102) with etched facets and optional coatings (1108), coupled the optical waveguides (1104), which in turn are connected to their respective photonic circuits (1106). The two photonic circuits (1106) can be independent, or can be the same circuits, and conversely the photonic circuit (1006) in FIG. 16(a) can be two or more uncoupled circuits. Similar to substrate #1 (1000), the facets (1108) are etched, rather than cleaved. Similar to substrate #1 (1000), substrate #2 (1100) is assumed to be monolithically integrated, and because the facets are not placed at the out edges of the substrate, they have to be etched rather than cleaved. Below, another embodiment is presented where heterogeneous integration of a substrate allows the facets to be cleaved even when not at the outer edges of the substrate. In substrate #2 there are at least two surfaces that can be used for bonding to another substrate: top surface (1110) and recessed surface (1112). FIG. 16(b) also illustrates the direction of light entering or leaving the facets, and this direction is represented by optical beam axis (1114). Similar to substrate #2, the axis intercepts the chip at its edge rather than through any of its horizontal planes, such as top surface (1110), recessed surface (1112) or its bottom surface (1116), as to constitute edge coupling, rather than surface coupling.

FIG. 16(c) illustrates how the two substrates are oriented towards each other just before bonding, and FIG. 16(d) show the two substrates just after the bonding, where the alignment of the optical beam axes for the two substrates is illustrated as well. In this embodiment, recessed surface of substrate #1 (1010) and top surface of substrate #2 (1110) are the primary bonding surfaces. Alternatively, as shown in FIG. 16(e), the bonding can be primarily facilitated by recessed surface of substrate #2 (1012) and top surface of substrate #1 (1112).

In FIG. 16, the cross-sectional side-view of the two chips shows their optically coupled SSCs as being co-linear. Although that is one of the embodiments of this invention, any two optically coupled SSCs do not have to be co-linear and they may be positioned at an angle relative to each other. This is similar to positioning a facet of an optical fiber coupled to a SSC of a device at an angle relative to the SSC, which is typically done to minimize the reflections at the interfaces.

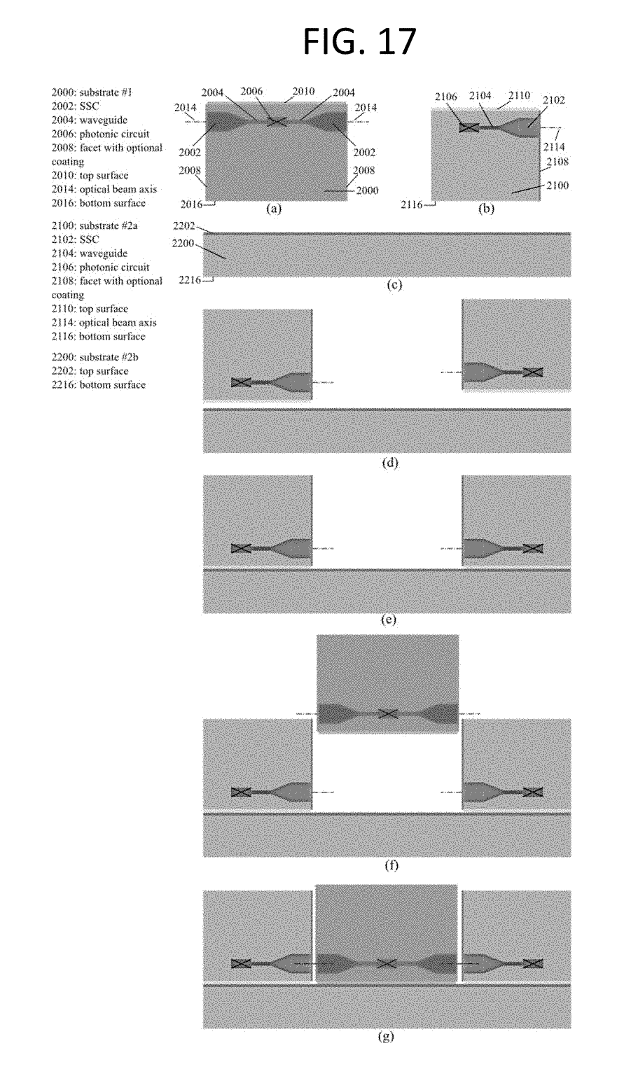

FIG. 17 illustrates a heterogeneous, rather than a monolithic implementation of substrate #2, where substrate #2 is composed of substrate #2b (2200), as shown in FIG. 17(c) and at least one instance of substrate #2a (2100), as shown in FIG. 17(b). Substrate #2a (2100) contains a photonic circuit (2106), waveguide (2104), and SSC (2102), which is positioned at the edge of the substrate. This placement of the SSC allows for the optionally coated facet (2108) to be cleaved, as well as etched. In FIG. 17(b), top and bottom surfaces (2110 and 2116) of substrate #2(a) are also shown, as well as the optical beam axis (2114).

FIG. 17(c) shows substrate #2b (2200), its bottom surface (2216), and its top surface (2202), and FIG. 17(d) shows how substrate #2b (2200) is oriented towards two instances of substrate #2a just before they are bonded in order to implement a heterogeneously integrated version of substrate #2 (1100) shown in FIG. 16. FIG. 17(e) shows the heterogeneously integrated substrate, which has the two facets not placed at the outer edges, and, still the two facets can be cleaved, not only etched. Here, the bonding is done using top surface (2202) of substrate #2b and top surfaces (2110) of the two substrates #2a.

FIG. 17(f) shows how the version of substrate #1 shown in FIG. 17(a) (2000) can be integrated with the heterogeneously integrated matching substrate, where the two substrates are shown just before the bonding. FIG. 17(g) shows the two substrates after the bonding. Here, the features in substrate #1 (2000) are similar to those in FIG. 16, and are the following: SSC (2002), waveguide (2004), photonic circuit (2006), top surface (2010), bottom surface (2016), and outward facing facets (2008), which can be etched as well as cleaved. The two optical beam axes (2014) are also shown in the figure.

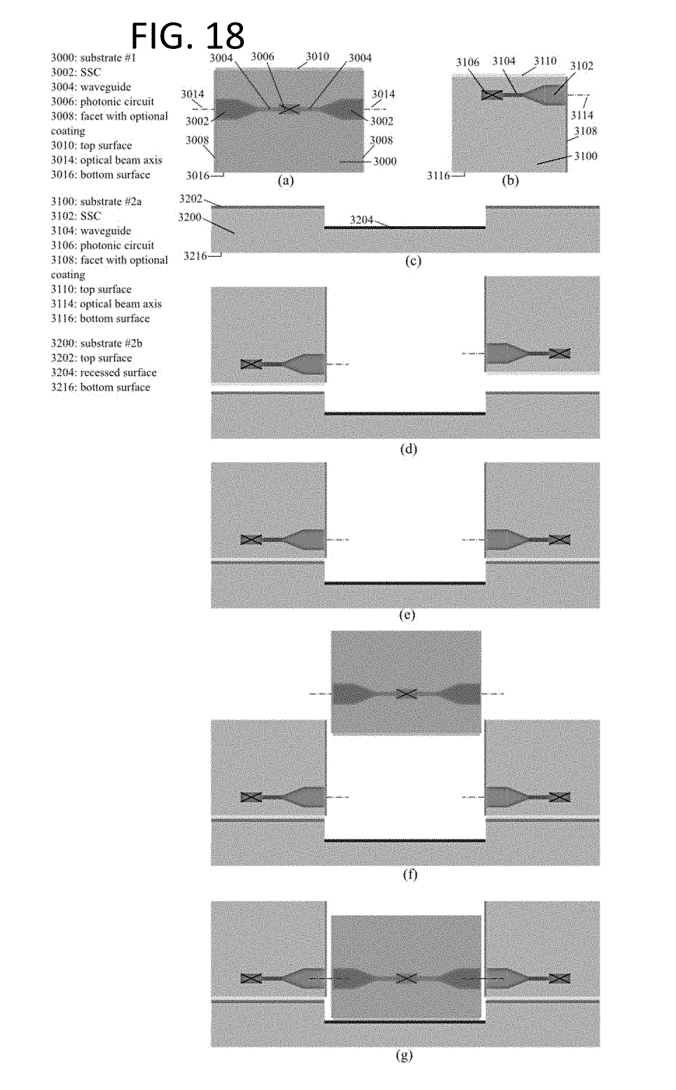

FIG. 18 shows an embodiment very similar to the one in FIG. 17, except, here, structure #2b (3200) has an additional recessed surface (3204), as shown in FIG. 18(c). The recessed surface is used to accommodate substrate #1 (3000) and its, now, larger separation between top surface (3010) use in bonding and its optical beam axis (3014). Similarly, a pedestal can be used instead of a recess in order to align the relevant optical beam axes.

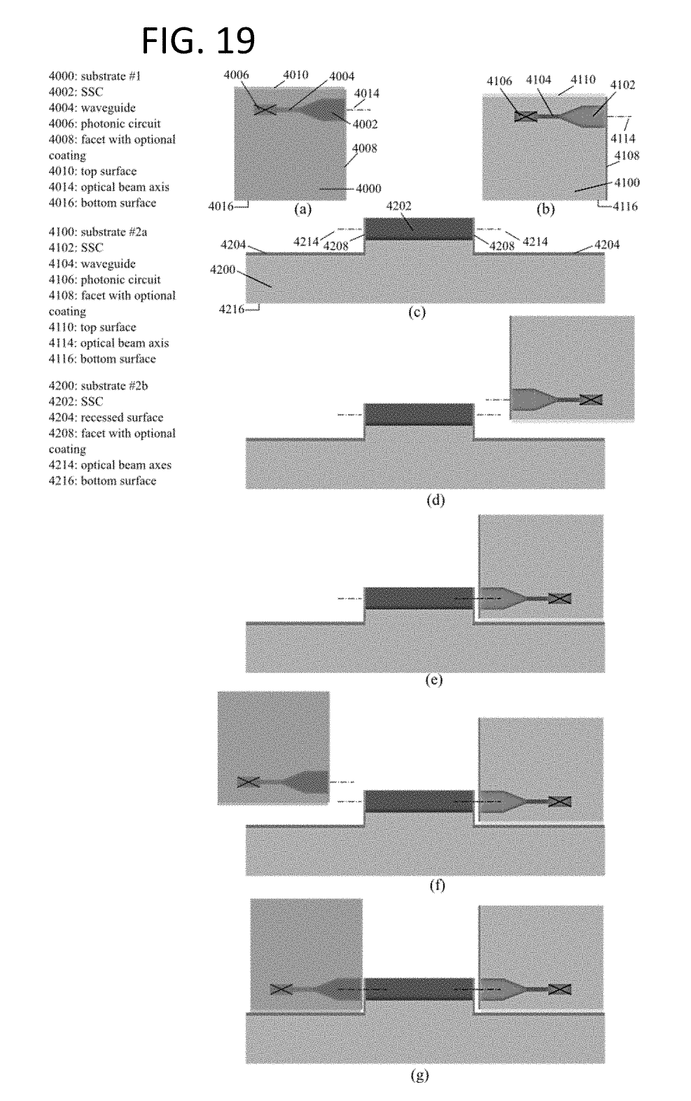

FIG. 19 illustrates yet another way to heterogeneously integrate a substrate before it is attached and optically coupled to another substrate. Here, two substrates, substrate #2b (4200) and only one instance of substrate #2a (4100), are bonded to form a heterogeneous substrate. More instances of substrate #2a can be used as well, as shown in FIGS. 17 and 18. In this embodiment, however, substrate #2b (4200) is more complex, and it contains a SSC (4202) with an optionally coated facet (4208). It is straightforward to add more complexity to substrate #2b so it has more important optical, electronic, and other components in addition to the SCC.

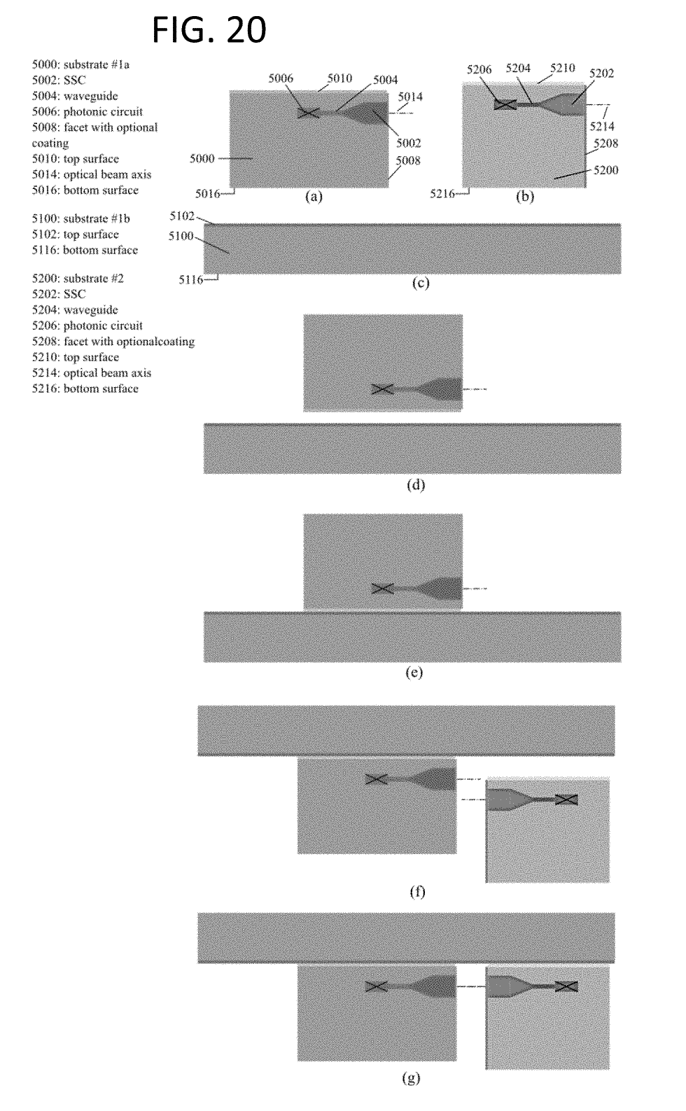

Similarly, it is possible to heterogeneously integrate substrate #1 as well, as shown in FIG. 20, where the substrate is a heterogeneous integration of substrate #1a (5000), shown in FIG. 20(a) and substrate #1b (5100), shown in FIG. 20(c). Here, substrate #1a (5000) and substrate #1b (5100) are first oriented and prepared for bonding, as shown in FIG. 20(d), and then bonded to form a heterogeneous substrate, as shown in FIG. 20(e). FIG. 20(f) shows how this substrate is then properly oriented and prepared for bonding with substrate #2 (shown in FIG. 20 (b)), and the final attachment and optical alignment of the two substrates is shown in FIG. 20(g). In FIG. 20, it is also shown that the orientations of the two substrates are arbitrary, and that either substrate can be attached on the top of the other. Also, both substrates can be monolithically integrated, one can be heterogeneously integrated, or both can be heterogeneously integrated. Other similar variations of the heterogeneous integration and the orientation during bonding and are easily derived.

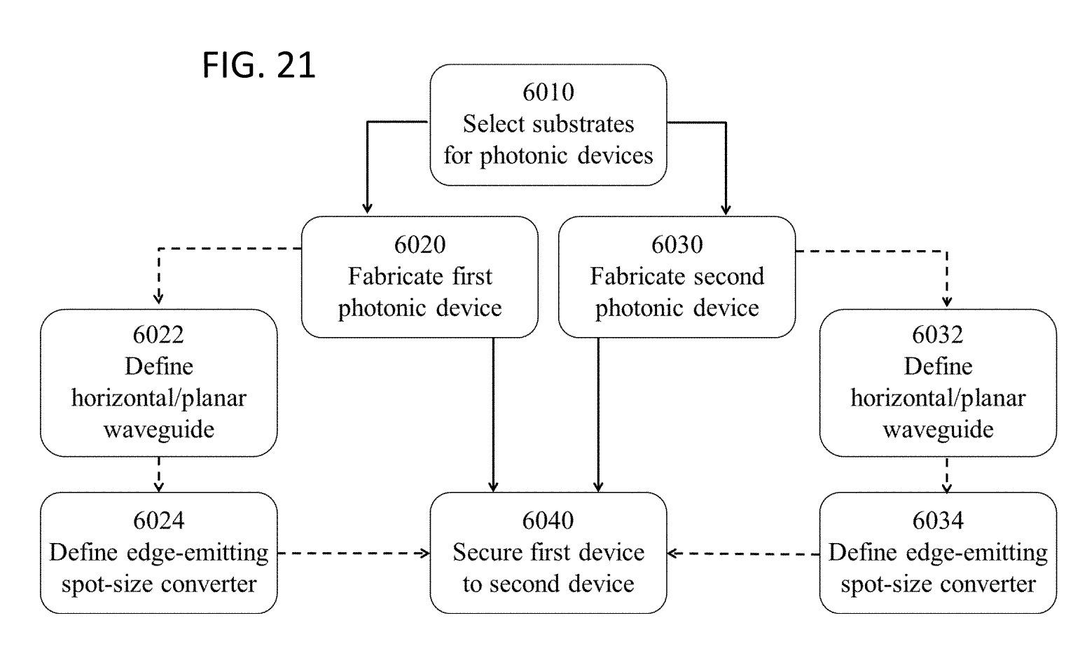

FIG. 21 summarizes the flow of integrating two photonic devices into a photonic circuit according the present invention. In the first step (6010), substrates are selected for the photonic devices. The photonic devices are then fabricated in two different steps (step 6020 and 6030). The two devices are then attached to each other (6040). The flow diagram also shows more details for both of the two photonic device fabrication steps (6020 and 6030). In fabrication of the first device (6020), a horizontal (planar) optical waveguide (6022) and an associated edge-emitting spot-size converter (6024) can be defined. Similar two steps of defining a horizontal (planar) optical waveguide (6032) and defining an edge-emitting spot-size converter (6034) in the fabrication of the second photonic device (6030) are shown as well. Here, by the edge-emitting spot-size converter it is implied that the direction of the optical beam leaving or entering the facet of the photonic device is horizontal or substantially horizontal, or in other words, the optical beam is parallel or substantially parallel to a major plane of the corresponding substrate.

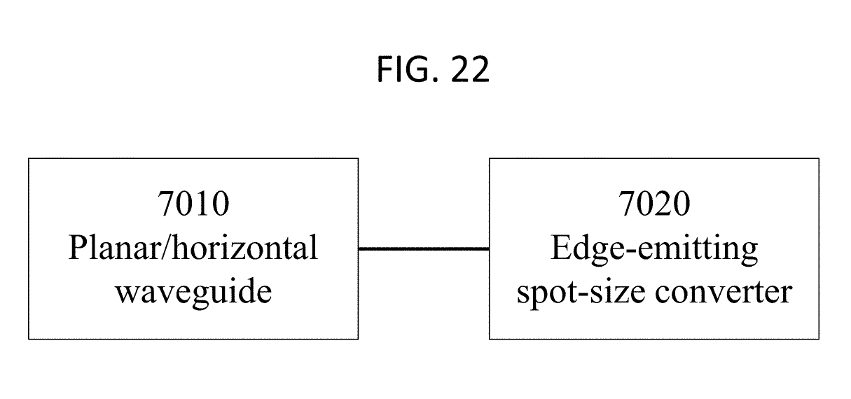

Spot-size converters are used for optical coupling. This point is emphasized in FIG. 22, where integration, either monolithic or heterogeneous, of an edge-emitting spot-size converter (7020) and a planar (horizontal) waveguide (7010) is illustrated. More than two devices can be integrated together using the present invention in a manner that is straightforward to generalize from the presented instructions for integration of two devices.

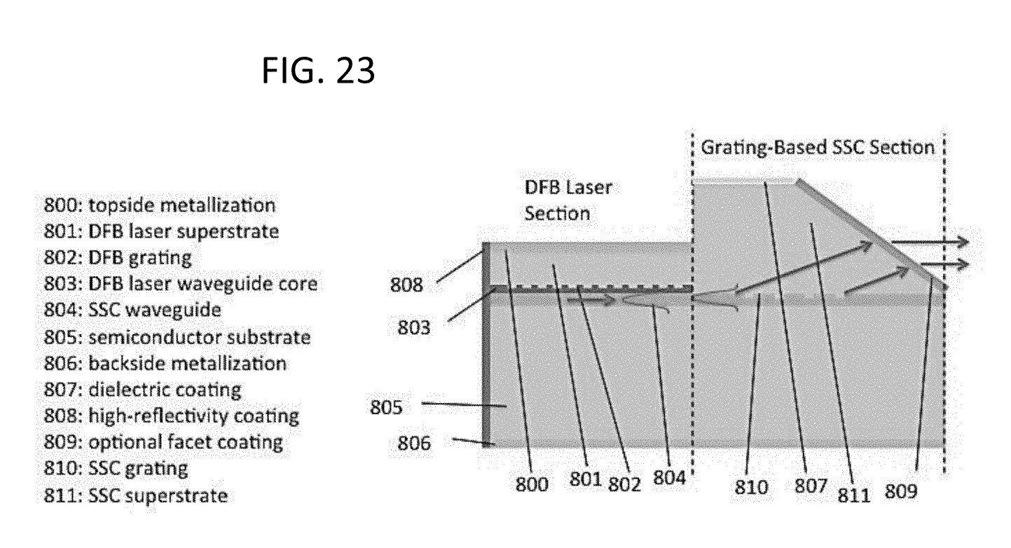

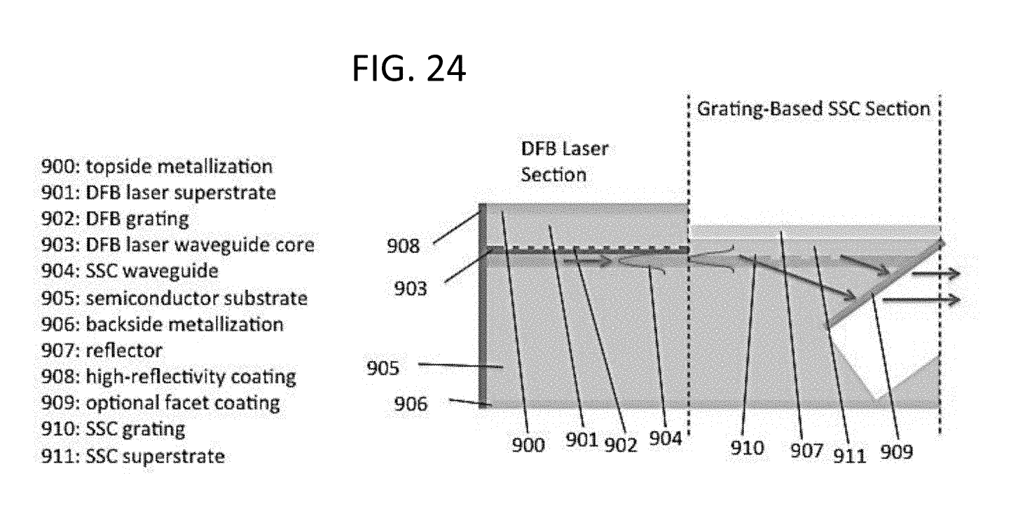

FIGS. 23 and 24 show a novel type of SSC that is claimed by the present invention. In FIGS. 23 and 24, the SSC is shown in a manner similar to that in FIGS. 10, 11, 13, and 14. As an example, the SSC is shown to be integrated with a laser, although it can be integrated with more complex optoelectronic integrated circuits, including both transmitters and receivers.

In FIG. 23, the DFB laser section is similar to that in FIG. 11, where the optical mode in the DFB laser only evanescently couples to the laser's active material, and the mode is mainly situated in the underlying waveguide, here termed SSC waveguide (804). Evanescent coupling is used here only for illustration and other optical coupling mechanisms between the SSC and the rest of the circuits can be used. This approach is discussed herein in the Grating-Based SSC section. An optical grating, an SSC grating (801), is used to direct light from the SSC waveguide through the SSC superstrate (811) and substrate edge, rather than through the top or the bottom surfaces of the substrate. The optical beam from by the SSC is incident on a vertically angled, optionally coated, etched facet (809), which redirects the beam in a desired direction. The output direction could be horizontal as that would simplify coupling to another substrate. The facet can be angled horizontally as well as vertically so that the light exits to a side of the SSC, rather than in front of it. The SSC embodiment of FIG. 23 allows for wet, crystallographic etching of the facet as well. Not only does the SSC grating radiate the beam of light at an angle to be received by the facet, but it also can change the size the size of the beam, its shape, and its divergence as required. An advantage of this type of SSC is that it can be made short relative to most of the SSC that typically utilize adiabatic tapering of the SSC waveguide, and the shorter lengths typically translate into lower costs of the devices. Also, this SSC offers an advantage by allowing crystallographic wet etching of smooth, high-quality facets with well-controlled angles.

Similar to typical 2^{nd} order gratings used to convert in-plane guided optical beam into an out-of-plane radiation, the SSC grating can radiate a substantial amount of power into the substrate, and special care must be paid in order to prevent this. One way would be to use asymmetric, blazed grating. Another way would be to place a reflector underneath the grating (not shown in FIG. 23), or have reflectors both on the bottom of the grating and on the top (both reflectors could be a Bragg stacks placed very closed to the grating) in order to create a resonance that would cause the radiation to exit in the desired direction. Also, a popular way to design efficient gratings is to use a so called “overlay” or “overgrowth,” where the waveguide in the grating region is made thicker than necessary for guiding in order to create resonances that would cause the radiation to go upwards rather than in the substrate. Other grating designs are possible as well. FIGS. 23 and 24 do not reveal the details of the grating design.

It should be noted that if the facet angle with respect to the horizontal plane were large, such as the angle that can be obtained with crystallographic semiconductor etching (˜55 deg.), the angle of radiation with respect to the vertical direction would also be large (˜70 deg.). This large radiation angle is very desirable and is typically not possible when gratings are used for surface-emitting coupling, as is typically done for grating fiber couplers. The large radiation angle provides at least the following benefits. First, the parasitic reflection coming from the 2^{nd} order diffraction is small for large radiation angles. Second, wave vector matching is easier and grating operation resembles more the true evanescent coupling, which, in turn, provides lower optical insertion losses. Third, the grating pitch can be made larger, even larger than 1 micrometer, so that it is easier to fabricate the grating. Gratings with larger pitch are easier to fabricate because more common and less expensive lithography, such as i-line stepper lithography stepper can be used instead of deep-UV lithography or e-beam lithography. In addition, large grating pitch is more conducive to fabrication of multi-level blazed gratings, which are important as they offer high directionality and low insertion loss. The larger the pitch, the smaller the effect of misalignment between successive patterning steps in a multi-level grating.

FIG. 24 shows an embodiment similar to the one in FIG. 23. Here, the grating is designed to radiate most of the light downwards, where the light encounters an angle-etched, optionally coated, facet. Similar to the embodiment in FIG. 23, the facet can be dry or wet etched. In FIG. 24, a reflector (907) is shown that can be used for redirecting the grating light radiation in the desired direction, i.e., downwards. In this embodiment, integration of the reflector is much simpler, where, simply a reflection layer of metal can be deposited on top of the SSC superstrate (911).

In both embodiments of FIGS. 23 and 24, the SSC grating can be made in a layer that is not necessarily present in sections outside the SSC (e.g., in the laser sections, as shown in FIGS. 23 and 24). The grating core layer, as well as the cladding layers bellow and above do not have to be made from semiconductor material and can be made from, for example, dielectrics such as silicon dioxide or silicon nitride, or can be made from spin-coated polymer, including electro-optic polymers. The choice of these materials can be used to control the refractive index contrast between the grating teeth and grooves, which is one of the fundamental properties of the grating. For example, the gratings with high-index contrast can be designed to have a broader wavelength response.

The complex refractive index of the grating layers used in the grating-based SSC can also be tuned by voltage, current, surface acoustic waves, light, and other means typically used in photonic devices. The term “complex refractive index” includes both the real part of the material index as well as the imaginary part of the material index, which is proportional to the optical absorption in the material. Typically, it is the real part of the index that is controlled in grating materials, in order to control the angle of grating radiation. This can be done in the embodiments of FIGS. 23 and 24, where the grating angle of radiation is adjusted to compensate for any angle variation in the etched facet. Also, for example, the ability to tune the angle of the grating radiation enables steering of the direction of the optical beam coming out of the substrate, which may be a useful functionality of the device employing the grating-based SSC.

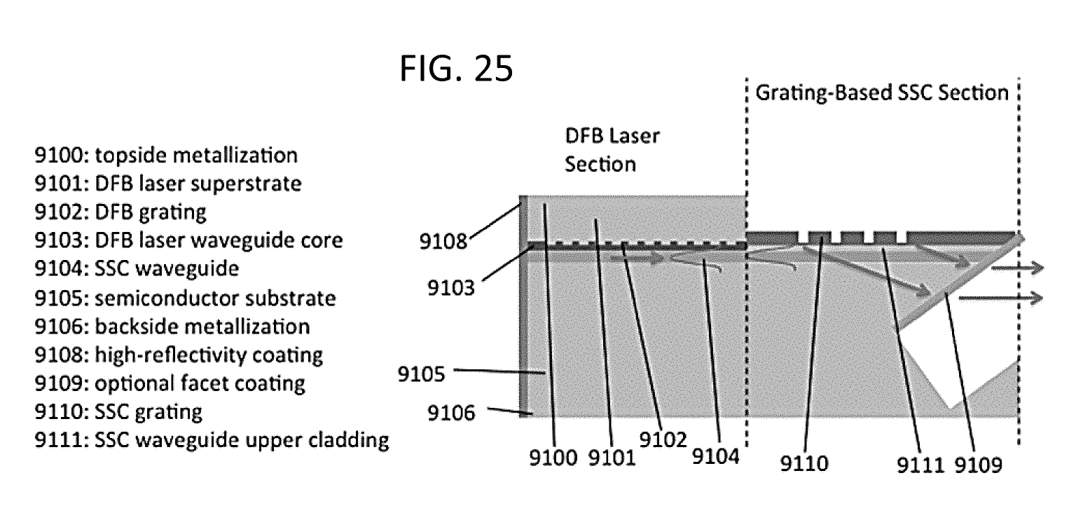

Similar to other embodiments of the present invention, the facet coating in the embodiments of FIGS. 23, 24, and 25 may not necessarily be designed and used only to minimize reflections, but it may also be designed and used to provide filtering as well as to provide back reflection. For example, a facet that would provide back reflection may be used to form, together with the grating-based SSC, a part of a laser cavity. This type of laser can additionally benefit from wavelength and angle filtering properties of the grating, which, again, can be tunable.

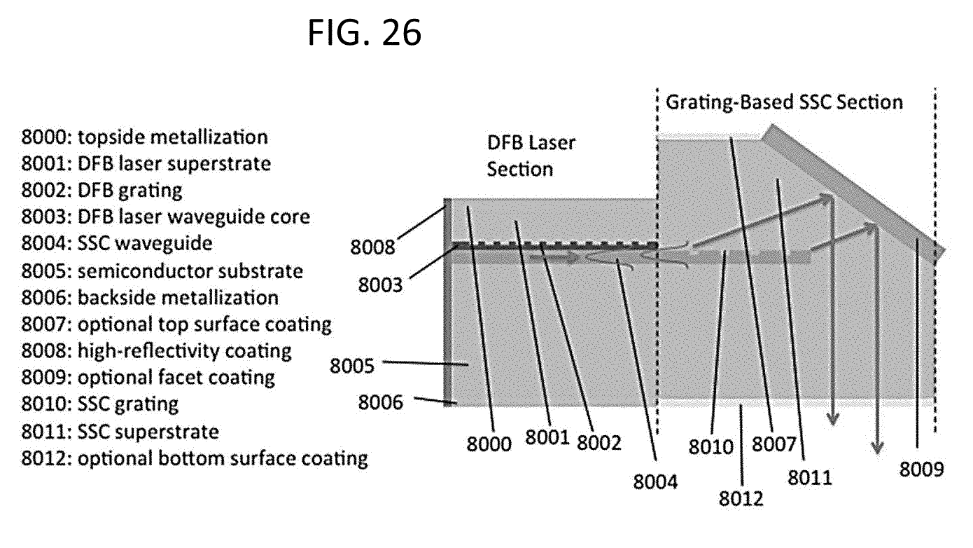

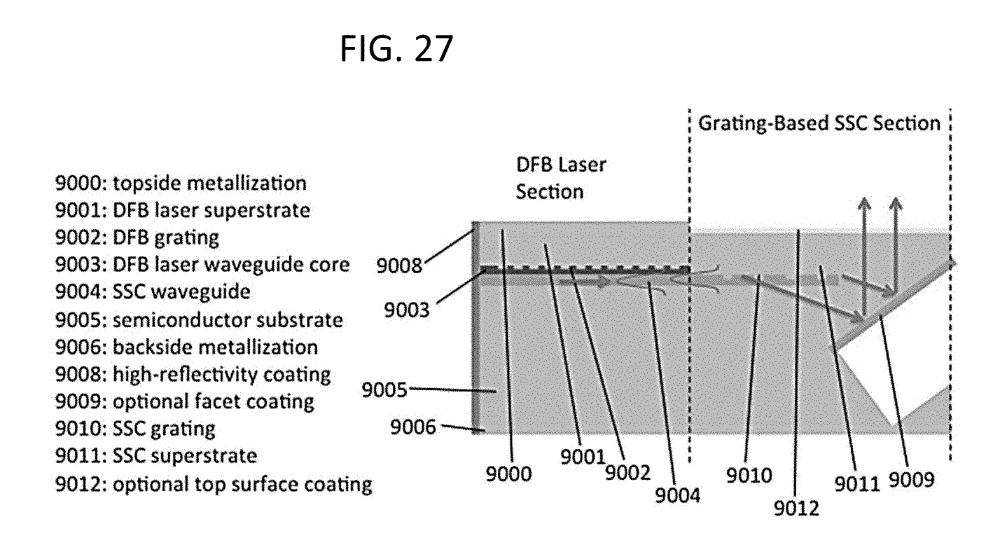

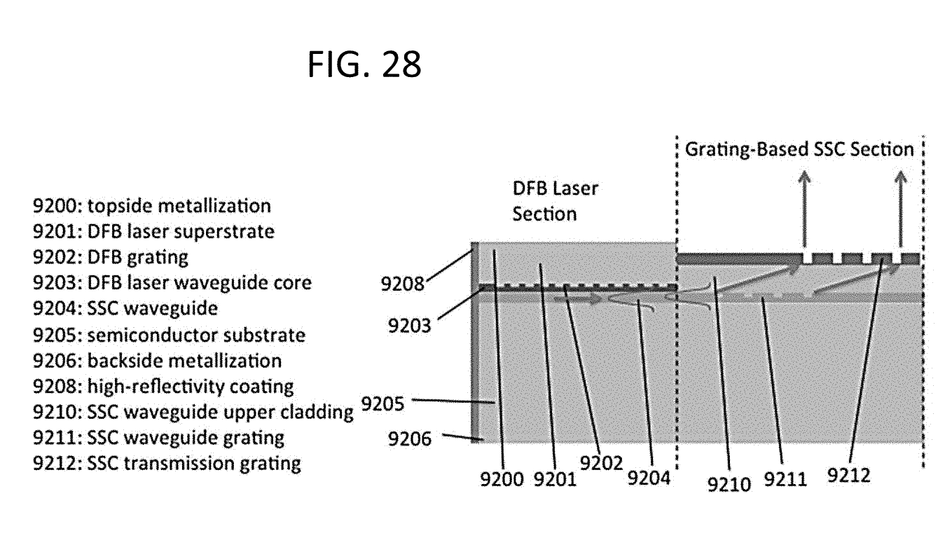

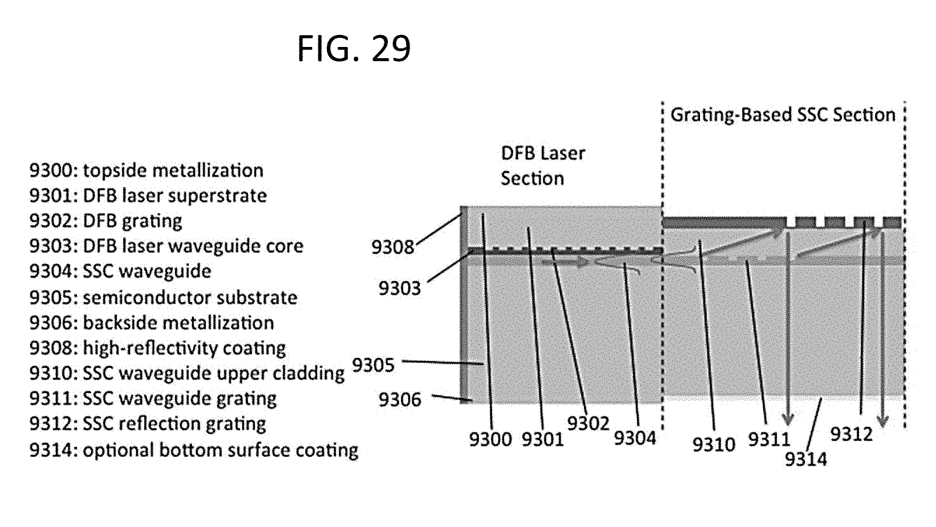

In the embodiment of FIG. 26, the bottom-surface coating (8012) can be coated to provide optical feedback (back reflection) rather that to minimize reflection. The same is true for the top-surface coating in the embodiment of FIG. 27 (9012). The transmission grating (9212) of the embodiment in FIG. 28 and the reflection grating (9312) of the embodiment in FIG. 29 can also be made to provide optical feedback to the photonic circuit in the substrate.

An SSC grating can be modulated in response to temperature, current, voltage, light exposure, or acoustic waves, and can thus be used as a sensor element. In addition, a gap can be provided between an emitter substrate and a detector substrate in which specimens can be situated to permit exposure to light and detection of light after interacting with the specimens. Such an arrangement can be used to evaluate specimen characteristics.

1. A method, comprising:
selecting a first optical substrate that includes a first planar optical waveguide, a first coupling facet situated on a beam propagation axis of the first optical waveguide, and a first spot size converter situated to optically couple the first coupling facet and the first planar optical waveguide;
selecting a second optical substrate that includes a second planar optical waveguide, a second coupling facet situated on a beam propagation axis of the second optical waveguide, and a second spot size converter situated to optically couple the second coupling facet and the second planar optical waveguide;
securing the second optical substrate with respect to the first optical substrate so as to optically couple the beam propagation axis of the first optical waveguide and the beam propagation axis of the second optical waveguide.

2. The method of claim 1, wherein at least the first spot size convertor (SSC) includes an SSC grating situated to optically couple the horizontal waveguide of the first substrate to the first coupling facet.

3. The method of claim 2, wherein at least the first coupling facet is situated to couple an optical beam into or out of the first substrate by transmission.

4. The method of claim 2, wherein at least the first coupling facet is situated to couple an optical beam into or out of the first substrate by reflection.

5. The method of claim 2, further comprising situating a coupling grating so as to optically couple at least the first spot size convertor to at least the first facet.

6. The method of claim 2, wherein at least one of the first coupling facet and the second coupling facet is situated at a compound angle.

7. The method of claim 1, wherein at least one of the first spot size convertor and the second spot size convertor is defined so as to adjust at least one of a size, shape, and divergence of a beam propagating along the beam propagation axis between the first optical waveguide and the second optical waveguide.

8. The method of claim 7, wherein the second optical substrate is secured to the first optical substrate.

9. The method of claim 8, wherein the first optical substrate and second optical substrate are secured to each other by direct molecular bonding, adhesive bonding, bonding with an interfacial layer, flip-chip metal thermocompression bonding, or flip-chip solder bonding at associated bonding surfaces.

10. The method of claim 7, further comprising contacting the first and second coupling facets.

11. The method of claim 7, further comprising optically coupling the first and second coupling facets by situating a liquid, optical filter, optical coating, optical isolator, index-matching material, polarizer, lens, hermetic sealant, or optical adhesive, resin or epoxy between the first and second coupling facets

12. The method of claim 7, further comprising situating the first and second coupling facets so as to define a gap between the first and second coupling facets.

13. The method of claim 7, wherein at least one of the first spot-size converter and the second spot-size converter are monolithically integrated to respective substrates.

14. A photonic circuit, comprising:
a first substrate having first and second major surfaces, the first substrate including a horizontal waveguide defined at the first major surface of the first substrate and a first spot size converter optically coupled to the horizontal waveguide;
a second substrate having first and second major surfaces, the second substrate having a horizontal waveguide defined at the first major surface of the second substrate and a second spot size converter optically coupled to the horizontal waveguide, wherein the first substrate and the second substrate are situated so that an optical beam propagating in the horizontal waveguide of the first substrate is coupled by the first spot size convertor to the second spot size convertor of the second substrate or an optical beam propagating in the horizontal waveguide of the second substrate is coupled by the second spot size convertor to the first spot size convertor of the first substrate.

15. The photonic circuit of claim 14, wherein at least one of the first substrate and the second substrate includes a facet that is optically coupled to the first spot size convertor or the second spot size convertor.

16-36. (canceled)

37. A photonic device, comprising:
an optical substrate that includes at least one planar optical waveguide;
at least one spot-size converter defined in the optical substrate and optically coupled to the planar optical waveguide, the spot-size converter situated to receive an optical beam propagating in the planar optical waveguide or to direct an optical beam to the planar optical waveguide, the spot-size converter producing a spot-size converted optical beam having at least one of a converted beam size, beam shape, and beam divergence.

38. The photonic device of claim 37, wherein at least one facet is defined in the substrate and optically coupled to the least one spot-size converter and situated to couple the spot-size converted optical beam by at least partly reflecting the beam or at least partly transmitting the beam so as to exit the substrate along an off-substrate optical beam axis.

39. The photonic device of claim 37, wherein at least one coupling grating is defined in the substrate and optically coupled to the least one spot-size converter and situated to couple the spot-size converted optical beam by at least partly reflecting the beam or at least partly transmitting the beam so as to exit the substrate along an off-substrate optical beam axis.

40. The photonic device of claim 38, wherein the spot-size converter includes a spot-size converter grating situated to receive an optical beam propagating in the horizontal waveguide and direct the optical beam to the at least one facet or to direct an optical beam from at least one facet to the planar optical waveguide, wherein an angle associated with the at least one facet is associated with a diffraction angle of the spot-size converter grating.

41. The photonic device of claim 39, wherein the spot-size converter includes a spot-size converter grating situated to receive an optical beam propagating in the planar optical waveguide and direct the optical beam to the at least one coupling grating or to direct an optical beam from at least one coupling grating to the planar optical waveguide, wherein a diffraction angle of the spot-size converter grating is associated with a diffraction angle of at least one coupling grating optically coupled to the spot-size converter.
